(19) United States
(12) Patent Application Publication
(10) Pub. No.: US 2026/0017005 A1
(43) Pub. Date: Jan. 15, 2026

(54) IMAGE DISPLAY METHOD AND DISPLAY APPARATUS

(71) Applicant: HISENSE VISUAL TECHNOLOGY CO., LTD., Shandong (CN)

(72) Inventors: Fei HUANG, Shandong (CN); Ruicong LIU, Shandong (CN); Baolong WANG, Shandong (CN); Minhua LI, Shandong (CN)

(21) Appl. No.: 19/336,119

(22) Filed: Sep. 22, 2025

Related U.S. Application Data
(63) Continuation of application No. PCT/CN2023/140020, filed on Dec. 19, 2023.

(30) Foreign Application Priority Data
Mar. 24, 2023 (CN) 202310302632.2
Mar. 30, 2023 (CN) 202310338569.8

(51) Int. Cl. G06F 3/14; G06F 3/0484; G09G 5/00

(52) U.S. Cl. CPC G06F 3/1407; G06F 3/0484; G09G 5/006; G09G 2330/12

(57) ABSTRACT

An image display method and a display apparatus. The display apparatus includes: a first control system, a second control system, a switch device and a screen, where N first control modules of the first control system are connected in series to form a first serial link; N second control modules of the second control system are connected in series to form a second serial link; when detecting that an (i+1)th first control module is abnormal, by means of the switch device, an i-th first control module sends to a first processor and a second processor indication information for indicating that the (i+1)th first control module is abnormal; the first processor controls display areas corresponding to first control modules before the (i+1)th first control module to perform image display; and the second processor controls the remaining display areas to perform image display.

### CROSS REFERENCES TO RELATED APPLICATIONS

The present application is a continuation of International Application No. PCT/CN2023/140020 filed on Dec. 19, 2023, which claims priorities to Chinese Patent Application No. 202310302632.2, filed on Mar. 24, 2023, Chinese Patent Application No. 202310338569.8, filed on Mar. 30, 2023, all of which are hereby incorporated by reference in their entireties.

### TECHNICAL FIELD

The present application relates to the technical field of display apparatuses, and in particular to an image display method and a display apparatus.

### BACKGROUND

The processor of the display apparatus can control the display to display images through the control module of the display apparatus. However, during the image display presentation, when the processor, the control module, or the communication between the modules is abnormal, the image display on the display will also be abnormal. Therefore, how to ensure that the display apparatus can display images normally is an urgent problem to be solved.

### SUMMARY

The present application provides a display apparatus, the display apparatus includes:
a screen configured to display an image;
a user interface configured to receive a command from a user;
a communication device configured to communicate with an external device according to a predetermined protocol;
a memory configured to store computer instructions and data associated with the display apparatus;
at least one processor, connected to the screen, the user interface, the communication device and the memory, and including a first processor and a second processor;
a first control system, a second control system, and a switch device; where:
the screen includes N display areas; where N is an integer greater than 1;
the first control system includes: the first processor and N first control modules; where the N first control modules are connected in series to form a first serial link, the first processor is connected to one end of a 1st first control module in the first serial link; each of the N first control module is connected to a display component of the screen in a corresponding display area through the switch device; the N first control modules correspond one-to-one to the N display areas;
the second control system includes: the second processor and N second control modules; where the N second control modules are connected in series to form a second serial link, and the second processor is connected to one end of a 1st second control module in the second serial link; each of the N second control module is connected to a display component of the screen in a corresponding display area through the switch device; the N second control modules correspond one-to-one to the N display areas; a display area corresponding to a i-th first control module in the first serial link is same as a display area corresponding to a (N−i+1)th second control module in the second serial link; i is an integer greater than or equal to 1 and less than N;
the i-th first control module in the first serial link is configured to execute the computer instructions to enable the display apparatus to:
detect whether a (i+1)th first control module in the first serial link has an abnormality;
based on that the (i+1)th first control module has an abnormality, send indication information indicating that the (i+1)th first control module has an abnormality to the first processor and the second processor through the switch device;
the first processor is configured to execute the computer instructions to enable the display apparatus to: in response to the indication information, control display areas corresponding to the 1st first control module to the i-th first control module in the first serial link to display an image;
the second processor is configured to execute the computer instructions to enable the display apparatus to: in response to the indication information, control display areas corresponding to the 1st second control module to a (N−i)th second control module in the second serial link to display an image.

The present application provides an image display method, which is applied to a display apparatus, where the display apparatus includes:
a screen configured to display an image;
a user interface configured to receive a command from a user;
a communication device configured to communicate with an external device according to a predetermined protocol;
a memory configured to store computer instructions and data associated with the display apparatus;
at least one processor, connected to the screen, the user interface, the communication device and the memory, and including a first processor and a second processor;
a first control system, a second control system, and a switch device; where:
the screen includes N display areas; where N is an integer greater than 1;
the first control system includes: the first processor and N first control modules; where the N first control modules are connected in series to form a first serial link, the first processor is connected to one end of a 1st first control module in the first serial link; each of the N first control module is connected to a display component of the screen in a corresponding display area through the switch device; the N first control modules correspond one-to-one to the N display areas;
the second control system includes: the second processor and N second control modules; where the N second control modules are connected in series to form a second serial link, and the second processor is connected to one end of a 1st second control module in the second serial link; each of the N second control module is connected to a display component of the screen in a corresponding display area through the switch device; the N second control modules correspond one-to-one to the N display areas; a display area corresponding to a i-th first control module in the first serial link is same as a display area corresponding to a (N−i+1)th second control module in the second serial link; i is an integer greater than or equal to 1 and less than N;
where the method includes:
detecting, through the i-th first control module in the first serial link, whether a (i+1)th first control module in the first serial link has an abnormality;
based on that the (i+1)th first control module has an abnormality, sending indication information indicating that the (i+1)th first control module has an abnormality to the first processor and the second processor through the switch device;
controlling, by the first processor, display areas corresponding to the 1st first control module to the i-th first control module in the first serial link to display an image in response to the indication information;
controlling, by the second processor, display areas corresponding to the 1st second control module to a (N−i)th second control module in the second serial link to display an image in response to the indication information.

### BRIEF DESCRIPTION OF FIGURES

FIG. 1 is a schematic structural diagram of a display apparatus according to some embodiments of the present application.

FIG. 2 is another schematic structural diagram of a display apparatus according to some embodiments of the present application.

FIG. 3 is another schematic structural diagram of a display apparatus according to some embodiments of the present application.

FIG. 4 is another schematic structural diagram of a display apparatus according to some embodiments of the present application.

FIG. 5 is another schematic structural diagram of a display apparatus according to some embodiments of the present application.

FIG. 6 is a flow chart of an image display method according to some embodiments of the present application.

FIG. 7 is a schematic diagram of a hardware configuration of a display apparatus according to some embodiments of the present application.

FIG. 8 is a schematic structural diagram of a display apparatus according to some embodiments of the present application.

FIG. 9 is a schematic structural diagram of another display apparatus according to an embodiment of the present application;

FIG. 10 is another schematic structural diagram of a display apparatus according to some embodiments of the present application.

FIG. 11 is another schematic structural diagram of a display apparatus according to some embodiments of the present application.

FIG. 12 is another flow chart of an image display method according to some embodiments of the present application.

### DETAILED DESCRIPTION

In order to make the purpose, implementation mode and advantages of the present application clearer, embodiments of the present application will be clearly and completely described below in conjunction with the drawings in embodiments of the present application. Obviously, the described embodiments are only part of the embodiments of the present application, not all of the embodiments.

It should be noted that the brief description of terms in the present application is only for the purpose of facilitating the understanding of embodiments described below, and is not intended to limit embodiments of the present application. Unless otherwise indicated, these terms should be understood according to their plain and ordinary meaning.

In addition, the terms “comprises” and “includes” and any variations thereof are intended to cover but not exclude inclusion, for example, a product or device including a list of components is not necessarily limited to those components expressly listed but can include other components not expressly listed or inherent to such product or device.

The processor of the display apparatus can control the display to display images through a control module, etc. However, during the image display presentation, when the processor, the control module, or the communication between the modules is abnormal, the image display on the display will also be abnormal. Therefore, how to ensure that the display apparatus can display images normally is an urgent problem to be solved.

The present application can be described in detail below with reference to specific embodiments. The following specific embodiments can be combined with each other, and the same or similar concepts or processes cannot be described in detail in some embodiments.

The display apparatus according to some embodiment of the present application can include:
a screen configured to display an image and/or a graphic user interface;
a user interface configured to receive a command from a user;
a communication device configured to communicate with an external device according to a predetermined protocol;
a memory configured to store computer instructions and data associated with the display apparatus;
at least one processor, connected to the screen, the user interface, the communication device and the memory, and including a first processor and a second processor;
a first control system, a second control system, and a switch device.

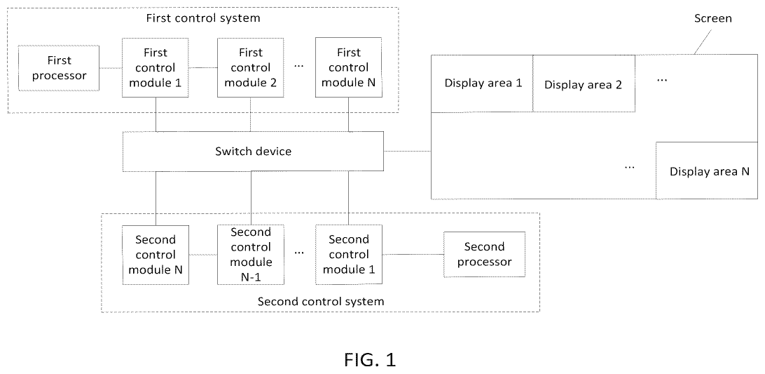

FIG. 1 is a schematic structural diagram of a display apparatus according to some embodiments of the present application.

As shown in FIG. 1, the screen can include N display areas, where N is an integer greater than or equal to 1. The present application does not limit the value of N.

The first control system can include: the first processor, and N first control modules. The N first control modules correspond one-to-one to the N display areas. The N first control modules can be connected in series to form a first serial link. The first processor can be connected to one end of the 1st first control module in the first serial link. Each of the first control modules can also be connected to a display component (not shown in FIG. 1) of a screen in a display area corresponding to the first control module through the switch device and each control module controls one display area, and different display areas are controlled by different control modules in the first serial link.

It should be noted that serial connection is a communication method that achieves data bit by bit transmission through serial communication technology, widely used for data transmission between computer systems and external devices. Serial communication refers to the transmission of data in bit order through a single signal channel, with one data bit transmitted at a time, and continuous transmission of data achieved through a serial interface. Compared with parallel communication (multi bit simultaneous transmission), serial communication only requires a small number of lines to complete data exchange. Serial connections are widely used for storage interfaces (such as Serial Attached SCSI (SAS)), remote communication, and computer expansion interfaces.

In some embodiments, an abnormality in the N-th control module in the serial link can cause the (N+1)th and subsequent control modules to fail to control the display properly.

In some embodiments, the first processor can be, for example, a system on chip (SoC) of the display apparatus, or a mainboard. Taking FIG. 1 as an example, the first control module 1 can correspond to the display area 1; the first control module 2 can correspond to the display area 2 . . . the first control module N can correspond to the display area N. As shown in FIG. 1, the first processor is connected to the first control module 1, and the 1st first control module in the first serial link formed by serially connecting the N first control modules can be the first control module 1. In some embodiments, the display components of the screen in the above-mentioned display areas can be any existing display components, which is not limited in the present application.

The second control system can include: the second processor, and N second control modules. The N second control modules correspond one-to-one to the above-mentioned N display areas. The N second control modules can be connected in series to form a second serial link. The second processor can be connected to one end of the first second control module in the second serial link. Each of the second control modules can also be connected to a display component (not shown in FIG. 1) of a screen in a display area corresponding to the second control module through the switch device.

In some embodiments, the second processor can also be, for example, the SoC of the display apparatus. Still taking FIG. 1 as an example, the second control module N can correspond to the display area 1; the second control module N-1 can correspond to the display area 2 . . . the second control module 1 can correspond to the display area N. As shown in FIG. 1, the second processor is connected to the second control module 1, and the 1st second control module in the second serial link formed by serially connecting the N second control modules can be the second control module 1.

The i-th display area corresponding to the i-th first control module in the first serial link and the display area corresponding to the (N−i+1)-th second control module in the second serial link are the i-th display area. Here, i can be an integer greater than or equal to 1 and less than or equal to N. For example, as shown in FIG. 1, the display area corresponding to the first control module 2 and the display area corresponding to the (N−1)th second control module are the same display area.

It should be understood that FIG. 1 is merely an exemplary illustration of the structure of the display apparatus, and the present application does not limit the manner in which the display area of the display is divided. In some embodiments, the sizes of different display areas of the display can be the same or different. The shapes of different display areas can be the same or different, and the present application does not limit this.

The first control system mentioned above can serve as the main control system of the display apparatus. The second control system can serve as a slave control system of the display apparatus. Each first control module in the first control system can be used to detect whether there is an abnormality in a first control module that is adjacent to and subsequent to the first control module. Because there is no first control module after the N-th first control module in the first serial link, the i-th first control module in the first serial link can be used to detect whether the (i+1)th first control module has an abnormality. As mentioned above, the (i+1)th first control module is a first control module that is located after and adjacent to the i-th first control module. In some embodiments, as shown in FIG. 1, taking the first control module 2 as an example, the first control module 2 can detect whether the first control module 3 has an abnormality. That is, in adjacent control modules in a serial link, the control module closer to the processor can detect the control module farther away from the processor.

In some embodiments, the above-mentioned “whether the (i+1)th first control module has an abnormality” can, for example, include at least one of: whether the self-test of the (i+1)th first control module is normal, whether the self-test of the display component connected to the (i+1)th first control module is normal, and whether the image display of the display area corresponding to the (i+1)th first control module is normal, etc.

When the (i+1)th first control module has an abnormality, the i-th first control module can send indication information “for indicating that the (i+1)th first control module has an abnormality” to the first processor. And, when the (i+1)th first control module has an abnormality, the i-th first control module can send indication information “for indicating that the (i+1)th first control module has an abnormality” to the second processor through the switch device.

In response to the indication information, the first processor can control the display area corresponding to “the 1st first control module to the i-th first control module in the first serial link” to display an image.

In some embodiments, still taking the (i+1)th first control module as the first control module 3 as an example, assuming that the first control module 2 determines that there is an abnormality in the first control module 3, the first control module 2 can send indication information indicating that there is an abnormality in the first control module 3 to the above-mentioned first processor and second processor through the above-mentioned switch device. Then, the first processor can respond to the indication information and control the display area corresponding to the first control module 1 and the display area corresponding to the first control module 2 to display the image through the first control module 1 and the first control module 2; and, the 3rd display area to the N-th display area are not controlled by the first processor.

The second processor can respond to the indication information and control the display area corresponding to the 1st second control module to the (N−i)th second control module in the second serial link to display the image. That is to say, the display areas corresponding to the above-mentioned 1st second control module to the (N−i)th second control module are the display areas except the display area controlled by the first processor. That is, the 1st display area to the (N−i+1)th display area are not controlled by the second processor.

In some embodiments, still taking the (i+1)th first control module as the first control module 3 as an example, the 1st second control module to the (N−i)th second control module in the above-mentioned second serial link are the second control modules corresponding to the display area 3 to the display area N, for example, the second control module 1 to the second control module N-2. Therefore, the second processor can respond to the indication information and control the display areas corresponding to the second control modules 1 to the second control modules N-2 to display the image through the second control modules 1 to the second control modules N-2.

In some embodiments, when the first control module 3 has an abnormality, the first processor can control the display area corresponding to the first control module 1 and the display area corresponding to the first control module 2 to display images. The second processor can control the display areas corresponding to the second control module 1 to the second control module N-2 to display images, so as to complete the display areas in the above-mentioned display except for the “display area corresponding to the first control module 1 and the display area corresponding to the first control module 2”, thereby ensuring the global display of the display.

In some embodiments, the display apparatus can include: a first processor, and N first control modules, a second processor, and N second control modules, and a switch device. The i-th first control module can detected whether the (i+1)th first control module has an abnormality, and when an abnormality exists, an indication information indicating that the (i+1)th first control module has an abnormality can be sent to the first processor; and when an abnormality exists, an indication information indicating that the (i+1)th first control module has an abnormality can be sent to the second processor through the switch device. Then, the first processor can control the display areas corresponding to “the 1st first control module to the i-th first control module” to display images, and the second processor can control the display areas corresponding to the 1st second control module to the (N−i)th second control module to display images. Through the above method, when the first control module has an abnormality, the first processor and the second processor jointly control the display to perform global display, ensuring that the display continues to display images while avoiding modular replacement. The present application can eliminate the need to re-establish modular communication connections and ports, improving the efficiency of restoring image display, and ensuring the global restoration of the display, thereby enhancing user experience.

In some embodiments, after controlling the display areas corresponding to the 1st second control module to a (N−i)th second control module in the second serial link to display the image, a (N−i+1)th second control module in the second serial link can detect whether the i-th first control module in the first serial link has an abnormality; based on that the i-th first control module in the first serial link has an abnormality, switch a i-th display area corresponding to the i-th first control module to be controlled by the (N−i+1)th second control module in the second serial link; a (N−i+2)th second control module in the second serial link can detect whether a (i−1)-th first control module in the first serial link has an abnormality until a corresponding first control module in the first serial link being normal; or a (N−i+2)th second control module in the second serial link can detect whether a (i−1)-th first control module in the first serial link has an abnormality by a (N−i+2)th second control module in the second serial link until an abnormality in the 1st first control module has been detected and all display areas are controlled by the second control system.

That is, when the i-th first control module in the first control system detects an abnormality in the (i+1)th first control module, and the (N−i)th display area to N-th display area is switched to be controlled by the (N−i)th second control module to 1st second control module in the second control system, the (N−i+1)th second control module in the second control system detects whether the i-th first control module in the first control system is abnormal. When the i-th first control module is abnormal, the i-th display area corresponding to the i-th first control module is first switched to be controlled by the (N−i+1)th second control module, and then the (N−i+2)th second control module in the second control system detects whether the (i−1)th first control module in the first control system is abnormal, . . . until the first control module in the first control system is detected to be normal, or until the abnormality in the 1st first control module has been detected and all display areas are controlled by the second control system.

In some embodiments, taking the (i+1)th first control module is the first control module 3 as an example, when the first control module 2 detects an abnormality in the first control module 3 and switches from display area 3 to display area N to be controlled by the second control module N-2 to second control module 1, the second control module N-1 can detect whether the first control module 2 has an abnormality. When the first control module 2 has an abnormality, it can first switch the display area 2 corresponding to the first control module 2 to be controlled by the second control module N-1, and maintain the display area 1 to be controlled by the first control module 1 in the first control system. When there is no abnormality in the first control module 2, maintain the display area 1 to be controlled by the first control module 1 in the first control system, and maintain the display area 2 to be controlled by the first control module 2 in the first control system.

When the first module is abnormal, after maintaining the first control module 1 to control the display area 1, the second control module N can detect whether the first control module 1 in the first control system is abnormal until it detects that the first control module 1 is normal, or until it has detected that the first control module 1 is abnormal, and all display areas are controlled by the second control system.

In this way, when there is an abnormality in the first control module before (i+1)th first control module, the corresponding display area can be switched to be controlled by the corresponding second control module, without the need to switch all the first control modules in the first control system. This can reduce the number of line switches and prevent the second control module after (N−i)th second control module from being unable to control the display area before (i+1)th display area due to abnormalities.

In some embodiments, the display apparatus can also perform global switching of the control system.

For example, the above-mentioned second processor can also control the display area corresponding to the 1st second control module to the (N−i)th second control module in the second serial link to display the image, and then detect whether the N-th first control module in the first serial link has received the data required for displaying the image through the 1st second control module in the second serial link.

In some embodiments, the second processor can, for example, send a command to the 1st second control module in the second serial link, for indicating the second control module to detect the N-th first control module in the first serial link. Then, the 1st second control module in the second serial link can respond to the command and send a detection command to the N-th first control module in the first serial link, so that the first control module can feed back a detection result indicating whether the first control module has received the data required for displaying the image. Then, the 1st second control module in the second serial link can transmit the detection result back to the second processor. The second processor can determine, based on the detection result, whether the N-th first control module in the first serial link has received the data required for displaying the image.

When it is determined that the N-th first control module in the first serial link has not received the data required for displaying the image, it means that there is indeed an abnormality in the first control module in the above-mentioned first control system, resulting in the disconnection of the above-mentioned first serial link, and then the first processor is unable to send the data required for displaying the image to the N-th first control module in the first serial link. The second processor can control N display areas to display images through N second control modules. That is to say, when it is determined that there is an abnormality in the first control module of the first control system; the second processor can directly control the global display of the display through the second control modules in the second control system.

When it is determined that the N-th first control module in the first serial link has received the data required for displaying the image, it indicates that the first serial link is not disconnected. In some embodiments, under this implementation method, the first processor can continue to control the display areas corresponding to the 1st first control module to the i-th first control module to display images, and the second processor can control the display areas corresponding to the 1st second control module to the (N−i)th second control module to display images.

In some embodiments, before performing global switching of the control system, the second processor can detect whether the N-th first control module in the first serial link receives the data required for displaying the image through the 1st second control module in the second serial link, and when it is determined that the N-th first control module in the first serial link has not received the data required for displaying the image, it is determined that there is indeed an abnormality in the first control module in the first control system. Then, the second processor can control the N display areas to display images through the N second control modules, thereby controlling the global display of the display. By using the above method, before performing global switching, the influence of situations such as electrostatic interference on the judgment of whether the first control system is abnormal is eliminated, thereby improving the accuracy of global switching. By controlling the display of the monitor through global switching, the accuracy of the image display of the monitor is improved, and the user experience is enhanced.

In some embodiments, before global replacement, the data required for displaying images cached by the display component in the display area corresponding to the first control module can also be deleted. By deleting the cached image data of the display component, it is possible to avoid the display component displaying images based on the cached image data from the first processor, further improving the accuracy of the displayed content and enhancing the user experience.

For example, taking the example that the display component corresponding to any one of the above-mentioned display areas includes at least one driver module, and any one of the above-mentioned first control modules can be connected to at least one driver module in the corresponding display area, the second processor can also delete the data required for displaying the image cached by at least one driver module in the display area corresponding to “the 1st first control module in the first serial link to the i-th first control module in the first serial link” before controlling the N display areas for displaying the image through N second control modules.

In some embodiments, taking the (i+1)th first control module as the first control module 3 as an example, the first control modules before the (i+1)th first control module in the first serial link are the first control module 1 and the first control module 2. That is, the second processor can also delete the data required for displaying the image cached by at least one driver module in the display area corresponding to the first control module 1 and the first control module 2.

In some embodiments, any one of the second control modules in the second control system can be connected to at least one driver module in the corresponding display area. In this implementation, the second processor can send a cache clearing command through at least one driver module in the display area corresponding to each first control module before the (i+1)th first control module in the first serial link. Accordingly, the at least one driver module can respond to the cache clearing command and delete the cached data required for displaying the image.

It should be understood that the present application does not limit the connection relationship between the at least one driver module included in the above-mentioned display component. For example, the at least one driver module can be connected in series. The first control module can be connected to the first driver module in the serial connection, and the driver module at the end of the serial connection can be connected to the light board of the display.

In some embodiments, the data required for displaying the image cached by at least one driver module in the display area corresponding to the 1st first control module to the i-th first control module in the first serial link is the data required for displaying the image sent by the first processor. The second processor can first delete the cached data required for displaying the image before performing global switching display, thereby avoiding the display area corresponding to the first to i-th first control modules displaying image data from the first processor during global switching display. This ensures that the display displays image data from the second processor globally, ensuring the accuracy of global display and further improving the user experience.

In some embodiments, after being powered on, the first processor can further send first image data segmentation information (also referred to as MAP) to each first control module. Among them, the first image data segmentation information is configured to enable the first control module to segment the image data according to the first image data segmentation information when receiving the image data from the first processor, to obtain the image sub-data corresponding to the first control module, and to control the corresponding display area of the first control module to display the image according to the image sub-data.

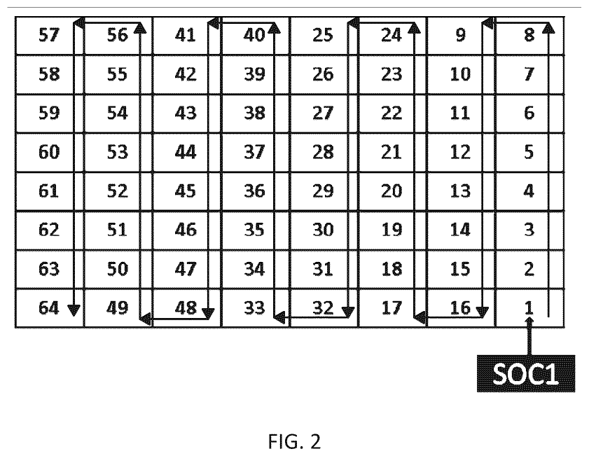

In some embodiments, taking N equal to 64 and the first processor being SOC1 as an example, FIG. 2 is another schematic structural diagram of a display apparatus according to the present application. As shown in FIG. 2, the sequence indicated by the arrows in FIG. 2 can be the direction from the start to the end of the first serial link. After receiving the first image data segmentation information, each first control module can, for example, store the first image data segmentation information in the first control module so as to obtain the first image data segmentation information from its own stored data in subsequent use. When there is no abnormality in each first control module, the first processor can send the image data to each first control module in the order shown in FIG. 2. Then, each first control module can obtain the image sub-data required by the display area corresponding to the first control module from the image data according to the first image data segmentation information, and control the display area to display the image according to the image sub-data.

By sending the first image data segmentation information to each first control module after power-on, each first control module can obtain the image sub-data required for displaying the image in the corresponding display area of the first control module based on the image data segmentation information, thereby improving the accuracy of image display.

In some embodiments, after the first processor is powered on, it is further possible to perform a self-test on the first processor and send a test command to each first control module to enable each first control module to perform a self-test. Then, the first processor can determine whether to perform global display through the second processor according to the self-test result of the first processor and the self-test result of each first control module.

In some embodiments, after being powered on, the first processor can further send a self-test command to the N-th second control module in the second serial link through the 1st first control module in the first serial link. By sending the self-test command, the second processor performs a self-test in response to the self-test command. Taking FIG. 1 as an example, after being powered on, the first processor can send a self-test command to the second control module N through the first control module 1.

In some embodiments, the second processor can also receive the self-test command through the N-th second control module in the second serial link after being powered on. Then, the second processor can respond to the self-test command, perform a self-test, and send the second image data segmentation information to each second control module.

Among them, the second image data segmentation information can be configured to enable the second control module to segment the image data according to the second image data segmentation information when receiving the image data from the second processor, to obtain the image sub-data corresponding to the second control module, and to control the corresponding display area of the second control module to display the image according to the image sub-data. In some embodiments, after receiving the second image data segmentation information, each second control module can, for example, store the second image data segmentation information in the second control module so as to obtain the second image data segmentation information from its own stored data during subsequent use.

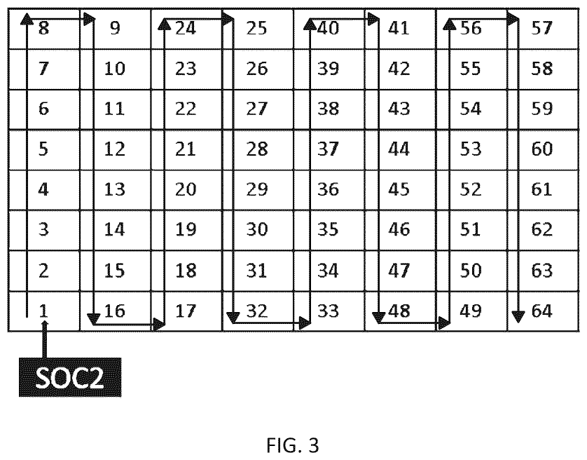

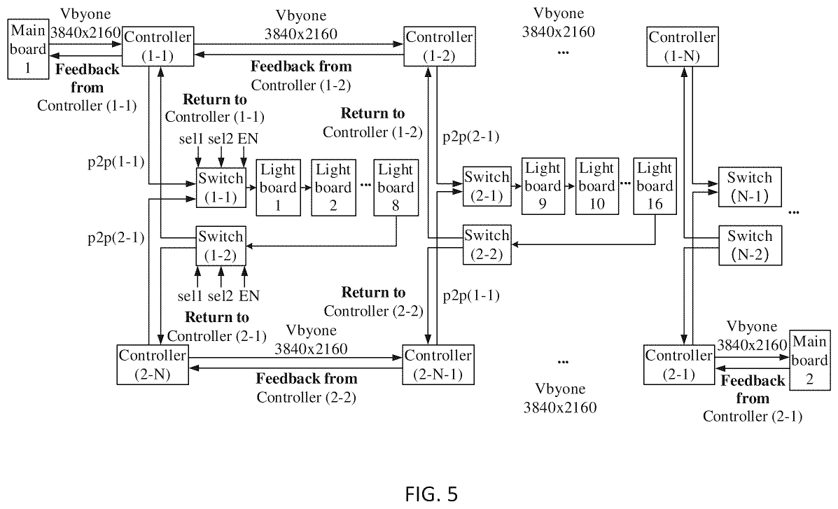

In some embodiments, taking N equal to 64 and the second processor being SOC2 as an example, FIG. 5 is another schematic structural diagram of a display apparatus according to the present application. As shown in FIG. 3, the order indicated by the arrows in FIG. 3 can be the direction from the start to the end of the second serial link. After receiving the second image data segmentation information, each second control module can, for example, store the second image data segmentation information in the second control module so as to obtain the second image data segmentation information from its own stored data in subsequent use. The second processor can send the image data to each second control module in the order shown in FIG. 3. Then, each second control module can obtain the image sub-data required by the corresponding display area of the second control module from the above image data according to the above second image data segmentation information, and control the display area to display the image according to the image sub-data.

In some embodiments, the N-th second control module in the above-mentioned second serial link can upload the self-test command to the second processor through P2P (the name of an existing communication technology) after receiving the self-test command from the 1st first control module in the first serial link.

The first image data segmentation information can be referred to as MAP1 (or a first MAP), and the second image data segmentation information can be referred to as MAP2 (or a second MAP). Taking the display apparatus shown in FIG. 2 and FIG. 3 as an example, the structural difference between MAP1 and MAP2 can be as follows: SOC1 is defined as Controller1 from the lower right, and Controller64 from the lower left. The lower left corner of SOC2 is defined as Controller1, and the lower right corner is defined as Controller64. Due to the difference between MAP1 and MAP2, the first control module and the second control module corresponding to the same number have different image acquisition positions, so the acquired image contents are different.

In some embodiments, the image content of the 64th partition after segmentation in MAP2 is the same as the image content of the 1st partition in MAP1, and the image content of the (64−i+1)th partition after segmentation in MAP2 is the same as the image content of the i-th partition in MAP1. Since the first controller and the second controller are displayed according to their respective numbers, it can be ensured that the image content in MAP1 and MAP2 corresponding to the same display area is the same.

It should be understood that the present application does not limit how the second processor performs self-test, how the first processor performs self-test, and how the first control module and the second control module perform self-test.

By sending the second image data segmentation information to each second control module after receiving the above-mentioned self-test command, each second control module can obtain the image sub-data required for displaying the image in the corresponding display area of the second control module based on the image data segmentation information, thereby improving the accuracy of image display.

Furthermore, in some embodiments, when the second processor does not receive the above-mentioned self-test command within the preset time period, it indicates that there can be an abnormality in the above-mentioned first control system, such as an abnormality in the first processor, or an abnormality in the 1st first control module in the first serial link, which causes the self-test command to be unable to be issued. Therefore, the second processor can also execute an operation of controlling N display areas to display images through N second control modules.

Through the above method, the second processor can directly perform global switching when it does not receive the above self-test command within the preset time period, and control N display areas to display images through N second control modules, thereby improving the efficiency of global switching.

The following is an exemplary description of how the first control module sends indication information “for indicating that an abnormality exists in the (i+1)th first control module” to the first processor and the second processor through the above-mentioned switch device.

In some embodiments, when the i+1th first control module has an abnormality, the i-th first control module can control the switch device to shut down the first channel “between the (i+1)th first control module to the N-th first control module in the first serial link and the corresponding display component”, and send the above-mentioned indication information to the first processor step by step through the (i−1)th first control module to the 1st first control module in the first serial link. The first control module can control the switch device to turn on the second channel “between the 1st second control module to the (N−i)th second control module in the second serial link and the corresponding display component”, and send the above-mentioned indication information to the second processor step by step through the (N−i)th second control module to the 1st second control module in the second serial link.

In some embodiments, the first control module in the first serial link can monitor whether the first channel “between the (i+1)th first control module to the N-th first control module in the first serial link and the corresponding display component” is turned off. After the first channel is turned off, the first control module in the first serial link can send the above-mentioned indication information “for indicating that the (i+1)th first control module has an abnormality” to the first processor.

In some embodiments, the second control module in the second serial link can monitor whether the second channel “between the 1st second control module to the (N−i)th second control module in the second serial link and the corresponding display component” is turned on. After the second channel is turned on, the second control module in the second serial link can send the above-mentioned indication information “for indicating that he (i+1)th first control module has an abnormality” to the second processor.

In some embodiments, when the (i+1)th first control module has an abnormality, the first control module can send the above-mentioned indication information to the first processor by turning off the above-mentioned first channel through the above-mentioned switch device, and can send the above-mentioned indication information to the second processor by turning on the above-mentioned second channel through the above-mentioned switch device. The above method lays the foundation for the subsequent switching of the control module.

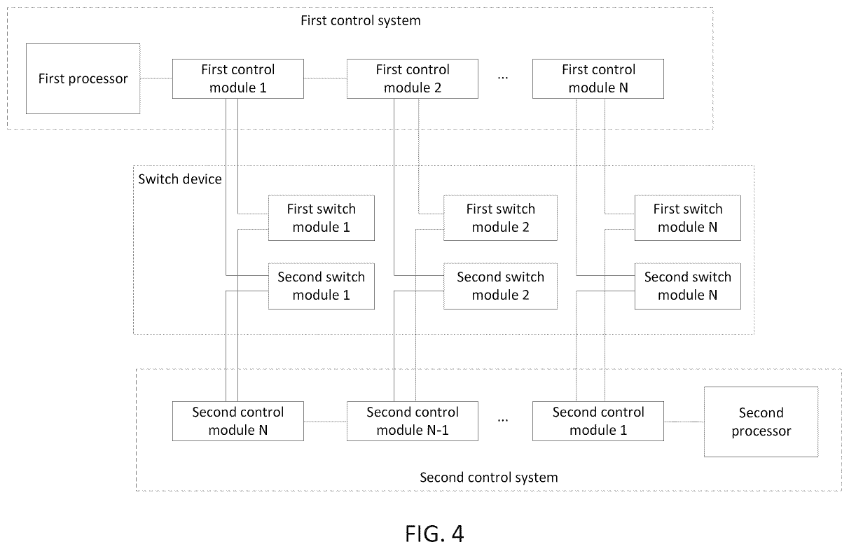

FIG. 4 is another schematic structural diagram of a display apparatus according to the present application. As shown in FIG. 4, in some embodiments, the switch device can include: N first switch modules and N second switch modules.

The N first control modules correspond one-to-one to the N first switch modules, and the N first control modules correspond one-to-one to the N second switch modules. For any one of the first control modules, the first control module can be connected to the display component of the screen in the corresponding display area through the first switch module corresponding to the first control module to form a transmitting sub-channel of the first channel (not shown in FIG. 4). The first control module can be connected to the display component of the screen in the corresponding display area through the second switch module corresponding to the first control module to form a receiving sub-channel of the first channel (not shown in FIG. 4).

In some embodiments, taking the first control module 1 in FIG. 4 as an example, the first control module 1 can be connected to the display component of the screen in the corresponding display area through the first switch module 1 to form a transmitting sub-channel of the first channel corresponding to the first control module 1. The first control module 1 can be connected to the display component of the screen in the corresponding display area through the second switch module 1 to form a receiving sub-channel of the first channel corresponding to the first control module 1.

In this implementation, when the first channel is turned on, the first control module can control the display component connected to the first control module to display images through the transmitting sub-channel of the first channel, and send an abnormality detection command to the display component. Then, the first control module can receive the first abnormality detection result from the display component through the receiving sub-channel of the first channel. The first abnormality detection result can be configured to indicate whether the display component has an abnormality.

It should be understood that the present application does not limit how the first control module can control the display component connected to the first control module to display an image through the transmitting sub-channel of the first channel when the first channel is turned on.

After receiving the above-mentioned abnormality detection command, the display component can perform a self-test, and after the self-test is completed, send the above-mentioned first abnormality detection result to the first control module through the receiving sub-channel of the above-mentioned first channel. In some embodiments, whether the display component is abnormal can include at least on of, for example, whether the display component has an abnormality in self-test, or whether the image display in the corresponding display area of the display component has an abnormality, etc.

The N second control modules can correspond one-to-one to the N first switch modules, and the N second control modules can correspond one-to-one to the N second switch modules. For any one of the second control modules, the second control module can be connected to the display component of the display in the corresponding display area through the first switch module corresponding to the second control module to form a transmitting sub-channel of the second channel (not shown in FIG. 4). The second control module can be connected to the display component of the display in the corresponding display area through the second switch module corresponding to the second control module to form a receiving sub-channel of the second channel (not shown in FIG. 4).

In some embodiments, taking the second control module 1 in FIG. 4 as an example, the second control module 1 can be connected to the display component of the display in the corresponding display area through the first switch module N to form a transmitting sub-channel of the second channel corresponding to the second control module 1. The second control module 1 can be connected to the display component of the display in the corresponding display area through the second switch module N to form a receiving sub-channel of the second channel corresponding to the second control module 1.

In this implementation, when the second channel is turned on, the second control module can control the display component connected to the second control module to display images through the transmitting sub-channel of the second channel, and send an abnormality detection command to the display component. Then, the first control module can receive the second abnormality detection result from the display component through the receiving sub-channel of the second channel. The second abnormality detection result can be configured to indicate whether the display component has an abnormality.

It should be understood that the present application does not limit how the second control module controls the display component connected to the second control module to display an image through the transmitting sub-channel of the second channel when the second channel is turned on.

After receiving the above-mentioned abnormality detection command, the display component can perform a self-test, and after the self-test is completed, send the above-mentioned second abnormality detection result to the second control module through the receiving sub-channel of the above-mentioned second channel. In some embodiments, whether the display component represented by the second abnormality detection result is abnormal can include at least one of, for example, whether there is an abnormality in the self-test of the display component, or whether there is an abnormality in the image display of the corresponding display area of the display component.

In some embodiments, the first processor and the second processor can be connected through a High Definition Multimedia Interface (HDMI) cable. In this implementation, the first processor can also obtain image data and send the image data to the second processor through the HDMI cable, so that the second processor can control the display area corresponding to the 1st second control module to the (N−i)th second control module in the second serial link to display the image according to the image data.

In some embodiments, the second processor can also obtain image data and send the image data to the first processor via the HDMI cable, so that the first processor can control the display area corresponding to the 1st first control module to the i-th first control module in the first serial link to display the image according to the image data.

It should be understood that the present application does not limit how the first processor or the second processor obtains the above-mentioned image data. In some embodiments, any method for obtaining image data by a display apparatus can be referred to, and details will not be repeated here.

In some embodiments, when an external device inputs image data to the display apparatus, the external device can be connected to the above first processor and input the image data to the first processor. Then, when the second processor needs to obtain image data, the first processor can send the image data to the second processor through the HDMI cable. When the external device inputs image data to the display apparatus, the external device can also be connected to the second processor and input the image data to the second processor. Then, when the first processor needs to obtain image data, the second processor can send the image data to the first processor through the HDMI cable. Therefore, through the above method, the external device can be connected to the first processor of the display apparatus, and can also be connected to the second processor. Therefore, the reverse serial backup system improves the flexibility of the internal space and external interface layout of the display apparatus, and improves the flexibility of connecting the display apparatus with external devices, thereby improving the universality of the display apparatus and the richness of applicable scenarios.

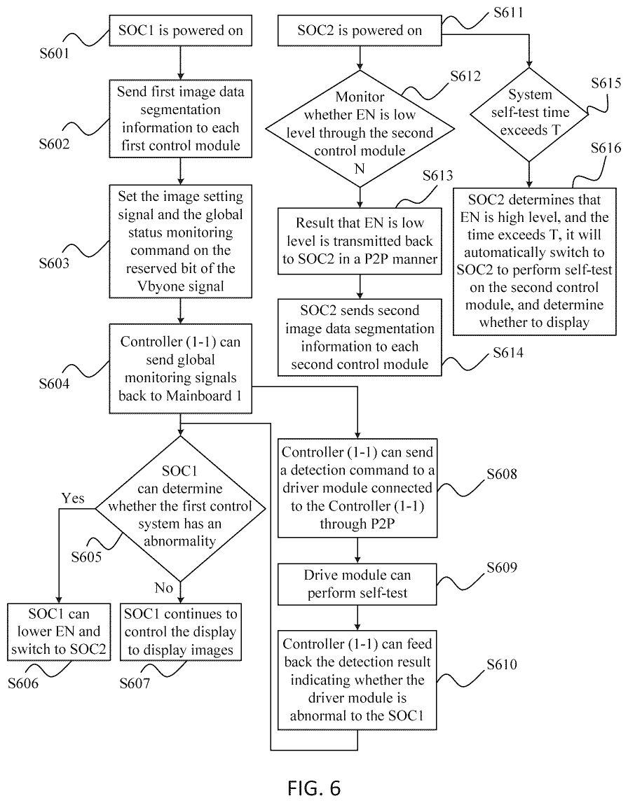

Taking the above-mentioned first processor as the mainboard 1, the second processor as the mainboard 2, the first control module 1 as the controller (1-1), the first control module 2 as the controller (1-2) . . . the first control module N as the controller (1-N); the second control module 1 as the controller (2-1), the second control module 2 as the controller (2-2) . . . the second control module N as the controller (2-N); the first switch module 1 as the switch (1-1), the first switch module 2 as the switch (2-1) . . . the first switch module N as the switch (N-1); the second switch module 1 as the switch (1-2), the second switch module 2 as the switch (2-2) . . . the second switch module N as the switch (N-2) as an example, FIG. 5 is another structural schematic diagram of a display apparatus according to the present application. Based on the display apparatus shown in FIG. 5, FIG. 6 is a flow chart of an image display method according the present application.

As shown in FIG. 5, the first control system where the main board 1 is located is a forward main transmission system, and the second control system where the main board 2 is located is a reverse slave transmission system. The forward main transmission system and the reverse slave transmission system can perform self-test switching.

As shown in FIG. 5, the light board refers to the light board of the display (a display can include multiple light boards, and FIG. 5 is an exemplary explanation based on the example of the above-mentioned N display areas, where each display area includes 8 light boards. The present application does not limit the number of light boards included in a display area). In some embodiments, each light board can correspond to at least one display component (not shown in FIG. 5). In some embodiments, for any one display component, the display component can include: at least one driver module (not shown in FIG. 5).

As shown in FIG. 5, for a display area corresponding to any first control module, the driver modules in the display area can be connected in series. One end of the serial connection (eg, light board 1) can be connected to a first switch module (eg, switch (1-1)), and the other end of the serial connection (eg, light board 8) can be connected to a second switch module (eg, switch (1-2)). Mainboard 1 (SOC1) can receive image signal input given by the external device, and then, Mainboard 1 can output the image signal to Controller (1-1), Controller (1-1) can output it to Controller (1-2), and so on, until it is output to Controller (1-N).

In some embodiments, as shown in FIG. 5, the corresponding relationship between Controller (1-1) and Controller (2-N) is illustrated. Controller (1-1) can be connected to the corresponding light board 1 in the display area through switch (1-1) to form the transmitting sub-channel of the first channel. Among them, light boards 1 to 8 are connected in series, and the detection data of light board 1 can be transmitted to light board 2. The detection data of light boards 1 and 2 can be transmitted to light board 3, and accumulated in sequence. The detection data of light boards 1 to 8 are collected at light board 8 for feedback to controller 1 or 2. Light board 8 is connected to Controller (1-1) through switch (1-2) to form the receiving sub-channel of the first channel. Controller (2-N) is connected to light board 1 through switch (1-1) to form the transmitting sub-channel of the second channel, and light board 8 is connected to Controller (2-N) through switch (1-2) to form the receiving sub-channel of the second channel. Among them, the transmitting sub-channel is used to send the display data and related control commands sent by the controller to the light board for display and detection. The receiving sub-channel is used to transmit the detection data of the light board back to the controller, thereby providing it to the corresponding SOC (mainboard 1 or mainboard 2).

It should be noted that the switch (1-1) can include at least two sub-channels, one sub-channel is used to form the transmitting sub-channel of the first channel, and another sub-channel is used to form the transmitting sub-channel of the second channel. Similarly, switch (1-2) can include at least two sub-channels; one sub-channel is used to form the receiving sub-channel of the first channel and another sub-channel is used to form the receiving sub-channel of the second channel. Control the selective conduction of the first and second channels through the signal line EN.

In some embodiments, when the signal line EN is at high level, the first channel is turned on (e.g. the transmitting sub-channel of the first channel and the receiving sub-channel of the first channel are turned on) and the second channel is turned off (e.g. the transmitting sub-channel of the second channel and the receiving sub-channel of the second channel are turned off); when the signal line EN is at a low level, the second channel is turned on (e.g. the transmitting sub-channel of the second channel and the receiving sub-channel of the second channel are turned on) and the first channel is turned off (e.g. the transmitting sub-channel of the first channel and the receiving sub-channel of the first channel are turned off).

In some embodiments, the presence of abnormalities in the first control module can be detected by the second control module. The abnormalities in the first control module are detected, such as whether the display of different display areas is synchronized, whether the signal quality is consistent, and whether the instruction status transmitted in the first control system is normal. Taking controller (2-N) to detect whether controller (1-1) is abnormal as an example, SOC2 can send a detection command to controller (2-N). Controller (2-N) can obtain the feedback result through the sub-channel formed by light board 8 and switch (1-2), and provide the result to SOC2 to determine whether controller (1-1) is abnormal.

As shown in FIG. 6, an image display method according to some embodiments of the present application can include the following operations.

S601, SOC1 is powered on.

S602, send MAP1 (ie, the aforementioned first image data segmentation information) to each of the first control modules.

S603, when outputting the image signal, the image setting signal and the global status monitoring command (for example, at least one of the aforementioned self-test command, channel switching command, and control system switching command) can be set on the reserved bit of the Vbyone signal.

Among them, SOC1 can also generate the highest priority signal to interrupt the hardware power-up and power-down interfaces.

S604, Controller (1-1) can send global monitoring signals back to Mainboard 1.

As shown in FIGS. 5 and 6, after the global status monitoring command is given to the Controller (1-1), the Controller (1-1) can send the image signal and the global status monitoring command together to the driver module on the light board 1 to light board 8 connected to the Controller (1-1) through the P2P channel and the switch (1-1). The controller (1-1) can transmit a global monitoring signal (which can include a detection result of whether the image display of the corresponding display area of all first control modules is abnormal) back to the mainboard 1, which is set as the monitoring signal C11.

S605, SOC1 can determine whether the first control system has an abnormality (for example, whether the screen displays in different display areas are synchronized, whether the signal quality is consistent, whether the instruction status transmitted in the first control system is normal, etc.) based on the above global monitoring signal.

S606, based on that the first control system has an abnormality, SOC1 can lower the potential of EN (ie, turned off the first channel) and switch to SOC2 (ie, globally switch to the second control system for global control).

It should be noted that, as shown in FIG. 5, both switch (1-1) and switch (1-2) are connected to the same EN signal line. SOC1 can raise or lower the potential on the EN signal line, that is, to keep the potential on the EN signal line at a low or high level. When the potential on the EN signal line is at a low level, switch (1-1) is turned off, the first channel is disconnected, switch (1-2) is turned on, and the second channel is conductive. For example, when SOC1 determines that there is an abnormality in the first control system, SOC1 can lower the potential on the EN signal line to a low level, causing the first channel to disconnect and the second channel to conduct. At this time, the light board 8 can transmit the signal to the Controller (2-N) and sequentially transmits the signal to the Controller (2-1) in the second control system, thereby providing it to SOC2 and then the second control system to control the corresponding display area.

S607, based on that there is no abnormality in the first control system, the SOC1 continues to control the screen to display images.

The monitoring signal (such as the first detection result mentioned above) of the driver module on the light board 1 to light board 8 connected to the controller (1-1) can be transmitted back to the controller (1-1) through the switch (1-2). This monitoring signal can be defined as D11.

S608, Controller (1-1) can send a detection command to a driver module connected to the Controller (1-1) through P2P.

S609, each drive module can perform self-test.

After completing the self-test, each driver module can feed back the self-test result to the Controller (1-1).

S610, Controller (1-1) can feed back the detection result indicating whether the driver module is abnormal to the SOC1.

Whether the driver module is abnormal can refer to whether the screen display corresponding to the display area is synchronized, whether the signal quality is consistent, or whether the instruction status of the driver module is normal, etc.

S611, SOC2 is powered on.

S612, SOC2 can monitor whether EN is at a low level (i.e. whether the level of switch (1-2) is low) through the second control module N.

S613: based on that the second control module N determines that EN is at low level, the result that EN is at low level is transmitted back to SOC2 in a P2P manner.

S614, SOC2 sends MAP2 (ie, the aforementioned second image data segmentation information) to each second control module.

S615, whether the system self-test time exceeds T.

S616, when EN is at a high level, the first control system controls the display area and performs a self-test on the first control system. If the self-test time (referring to the self-test time of the first control system) exceeds T, even if EN is at a high level at this time, the second control system does not receive the self-test result from the first control system within T time, indicating that there is a problem with the first control system. At this time, SOC2 will be forcibly switched to control. In some embodiments, after switching to SOC2 for control, the second control module can perform a self-test and determine whether to continue controlling the screen based on the self-test results. For signal monitoring and transmission, SOC1 starts from SOC1 to Controller (1-1), and then to Controller (1-N). Since SOC2 adopts the reverse serial mode, its monitoring body is dominated by Controller (2-N). After monitoring by Controller (2-N), the data is transmitted back to SOC2 through P2P for judgment. Then SOC2 can make a global judgment according to the forward logic, Controller1, and then Controller (2-N). After SOC2 makes the judgment, it completes the overall switching of the system again.

As shown in FIG. 5, sel1 and sel2 pointing to each switch can be configured to represent commands other than EN. For example, sel1 and sel2 can be configured to supplement the local transmission when the global command transmission of EN is not timely or the transmission bandwidth is insufficient. In some embodiments, the conduction or disconnected of sub-channels can be controlled by the cooperation of EN with sel1 and sel2.

In some embodiments, synchronous display switching of the global reverse serial system is achieved by adopting a method of real-time startup of a previous system backup based on the serial system, thereby achieving high system reliability and ensuring global zero-delay synchronous switching. And through the real-time feedback synchronization switching mechanism of the above-mentioned serial return channel, it is ensured that the operation information of the user operating the display apparatus can be synchronously returned by the system, thereby ensuring that the screen setting at any time is the screen setting required by the user, further improving the user experience.

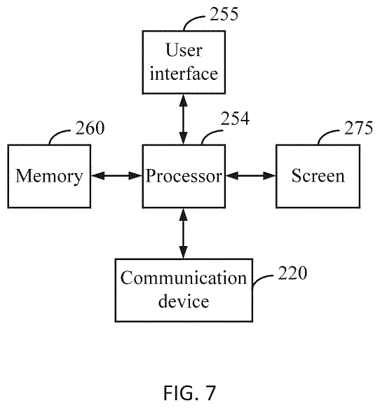

FIG. 7 is a schematic diagram of the hardware configuration of a display apparatus according to the present application. As shown in FIG. 7, in some embodiments, the display apparatus can include: a screen 275 configured to display an image and/or a graphic user interface; a user interface 255 configured to receive a command from a user; a communication device 220 configured to communicate with an external device according to a predetermined protocol; a memory 260 configured to store computer instructions and data associated with the display apparatus; at least one processor 254 connected to the screen 275, the user interface 255, the communication device 220, and the memory 260, and including a first processor and a second processor.

In some embodiments, the at least one processor 254 can be configured to execute operating system and application program instructions stored in the memory 260. And according to various interactive commands received from external input, various applications, data and content are executed to ultimately display and play various audio and video contents.

In some embodiments, the at least one processor 254 can include a main processor and one or more sub-processors. The main processor is configured to execute some operations of the display apparatus in the pre-power-on mode and/or display images in the normal mode. One or more sub-processors s configured to execute some operations in a state such as standby mode.

The screen 275 can be configured to display images. In some embodiments, the screen 275 can include a display component for presenting images. In some embodiments, depending on the type of screen 275, a driving component for driving the display is also included. In some embodiments, the display 275 can be a projection display and can further include a projection device and a projection screen.

In some embodiments, the display panel of the screen 275 can adopt a liquid crystal display (LCD), an organic light-emitting diode (OLED), an active-matrix organic light-emitting diode or an active-matrix organic light-emitting diode (AMOLED), a flexible light-emitting diode (FLED), Miniled, MicroLed, Micro-oLed, a quantum dot light-emitting diode (QLED), etc. In some embodiments, the display apparatus can include 1 or Q screens 275, where Q is a positive integer greater than 1.

In some embodiments, the communication device 220 can be a component for communicating with an external device or an external server according to various communication protocol types. For example, the communication device 220 can include at least one of a Wifi chip, a Bluetooth communication protocol chip, a wired Ethernet communication protocol chip, or other network communication protocol chips or a near field communication protocol chip, and an infrared receiver. In some embodiments, the display apparatus 200 can establish control signal and data signal transmission and reception with an external device or content providing device through the communication device 220.

In some embodiments, the memory 260 can include various software modules for driving the display apparatus, such as at least one of a basic module, a detection module, a communication module, a display control module, a browser module, and various service modules.

In addition to the above embodiments, the present application further provides other embodiments of image display methods and display apparatuses that can improve the efficiency of restoring image display.

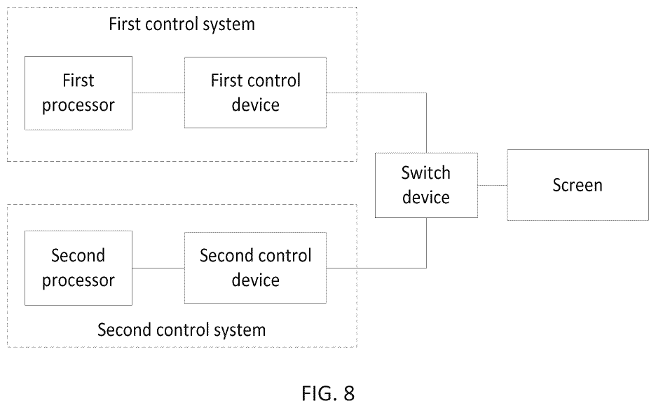

FIG. 8 is a schematic structural diagram of a display apparatus according to the present application. As shown in FIG. 8, the display apparatus can include: a first control system, a second control system, a switch device, and a screen.

The first control system can include: a first processor, and a first control device. A first end of the first processor is connected to a first end of the first control device, and a second end of the first control device is connected to the screen through a switch device.

The second control system can include: a second processor, and a second control device. A first end of the second processor is connected to a first end of the second control device, and a second end of the second control device is connected to the screen through a switch device.

The channel between the first control device and the screen is the first channel. The first processor can be configured to control the screen to display images when the first channel is turned on. In some embodiments, the first processor can be, for example, a system on chip (SoC) of the display apparatus.

The switch device can be configured to shut down the first channel “between the first control device and the screen” and conduct the second channel “between the second control device and the screen” when there is a communication abnormality in the first channel. Among them, the above-mentioned “communication abnormality in the first channel” can include at least one of: an abnormality of any device in the first control system (such as the first processor, any device in the first control device, etc.), an abnormality of communication between the first processor and the first control device in the first control system, or an abnormality of communication between the devices in the first control device, etc.

The second processor can be configured to control the screen to display images when the second channel is turned on. In some embodiments, the second processor can be, for example, the SoC of the display apparatus. It should be understood that the present application does not limit how the second processor controls the screen to display images, nor does it limit the content displayed on the screen.

In some embodiments, the first control device or the second control device can be an active control device or a passive control device, which is not limited in the present application. In some embodiments, the display panel of the above-mentioned screen can adopt a liquid crystal display (LCD), an organic light-emitting diode (OLED), an active matrix organic light-emitting diode or an active matrix organic light-emitting diode (AMOLED), a flexible light-emitting diode (FLED), Miniled, MicroLed, Micro-oLed, quantum dot light emitting diodes (QLED), etc. In some embodiments, the display apparatus can include 1 or Q screens. Among them, Q is a positive integer greater than 1.

In some embodiments, the display apparatus can include: a first control system, a second control system, and a switch device. The switch device can turn off the first channel between the first control device of the first control system and the screen when there is a communication abnormality in the first channel, and turn on the second channel between the second control device of the second control system and the screen. Then, the second processor of the second control system can control the screen to display images when the second channel is turned on. By using the above method, when a communication abnormality occurs in the above first channel in the first control system, the second control system is directly switched to control the screen to display images, thereby realizing global switching of the control system. Compared with the existing method of only replacing modules, the present application does not need to re-establish modular communication connections and ports, which improves the efficiency of restoring image display, ensures the global restoration of the display, and improves the user experience.

The following describes in detail how to determine whether there is a communication abnormality in the first channel.

In some embodiments, when the first control system is abnormal, it can be determined that there is a communication abnormality in the first channel. For example, the first processor can detect whether the first control system is abnormal. The abnormality of the first control system can include, for example, at least one of the following: an abnormality of the first control device, an abnormality of the display image, or an abnormality of the communication between the first processor and the first control device.

Taking the above-mentioned first control system abnormality including: the first control device abnormality as an example, in some embodiments, the first control device can, for example, have a self-test function, and after self-test, send the self-test result used to characterize whether there is an abnormality in the first control device to the first processor. Then, the first processor can determine whether there is an abnormality in the first control device according to the self-test result. In this implementation, it should be understood that the present application does not limit how the first control device performs self-test.

Taking the above-mentioned first control system abnormality including: abnormal display image as an example, in some embodiments, the first control device can, for example, detect whether there is any abnormality in the display image after controlling the screen to display the image. Then, the first control device can obtain a detection result indicating whether the image displayed on the screen is abnormal, and send the detection result to the processor. Then, the processor can determine whether there is any abnormality in the image displayed on the screen according to the detection result.

In some embodiments, the first control device can obtain image display related data of the screen (such as the brightness of the image display, or the chromaticity of the image display, etc.) after controlling the screen to display an image, and send the image display related data to the first processor. Then, the first processor can determine whether there is any abnormality in the image display according to the image display related data.

Taking the above-mentioned first control system abnormality including:
communication abnormality between the first processor and the first control device as an example, in some embodiments, the first processor can send a connection request for maintaining a communication connection to the first control device at a preset frequency. Then, when the first processor receives a connection response from the first control device within the preset communication time, the first processor can determine that there is no abnormality in the communication with the first control device. When the first processor does not receive a connection response from the first control device within the preset communication time, the first processor can determine that there is an abnormality in the communication with the first control device.

Taking an example that the first control system abnormality includes: an abnormality of the first control device, an abnormality of the display image, and an abnormality of communication between the first processor and the first control device, in some embodiments, the first processor can determine that the first control system is abnormal when any one of the first control device, the display image display, and the communication between the first processor and the first control device is abnormal.

Taking an example that the abnormality of the first control system includes: the abnormality of the first control device and the abnormality of the display image, the first processor can send target image data and an abnormality detection command to the first control device. In some embodiments, the first processor can add the above-mentioned target image data and the abnormality detection command into a piece of data and send the piece of data to the first control device to improve data transmission efficiency.

Then, the first control device can control the screen to display the target image using the first channel according to the target image data. It should be understood that the present application does not limit how the first control device controls the screen to display the target image using the first channel according to the target image data. For example, any existing method for controlling a screen to display an image can be referred to, which will not be described in detail here.

Then, the first control device can obtain a detection result for characterizing whether there is an abnormality in the first control device and whether the image display on the screen is abnormal according to the above-mentioned abnormality detection command, and send the detection result to the first processor so that the first processor can detect whether the first control system is abnormal based on the detection result.

In some embodiments, the implementation method of the first control device determining whether there is an abnormality in the first control device can refer to any existing self-testing method of the control device of the display apparatus, which will not be described in detail here. For example, the first control device can determine that the first control device has an abnormality only when any component in the first control device has an abnormality, or when communication abnormality exists between components. When the first control device determines that any component in the first control device is normal and there is no abnormality in the communication between the components, it can be determined that there is no abnormality in the first control device.

In some embodiments, the first processor can determine that there is no abnormality in the first control system when the above detection result is used to indicate that there is no abnormality in the first control device and the display image shows that there is no abnormality. In some embodiments, the first processor can determine that there is no abnormality in the first control system when the above detection results are used to indicate that there is no abnormality in the first control device, the display image shows no abnormality, and the first processor self-test shows no abnormality. When the first processor determines, based on the above detection results, that any one of the first control device, the display image display, or the first processor self-test is abnormal, it can be determined that the first control system is abnormal.

When the first control system is abnormal, the first processor can determine that a communication abnormality exists in the first channel. Then, the first processor can send a channel switching command to the switch device, so that the switch device turns off the first channel and turns on the second channel. Correspondingly, the switch device can receive the channel switching command and, in response to the channel switching command, shut off the first channel and turn on the second channel. By shutting off the first channel and conducting the second channel, the second processor can globally replace the first control system when the first control system is abnormal, and control the screen to display images.

In some embodiments, the display apparatus can also perform a power-on self-test during the power-on process to further ensure that the display apparatus can display images normally after powering on. For example, the first processor can detect whether there is any abnormality in the first control system during the initialization process of powering on the display apparatus. In some embodiments, the specific implementation method of the first processor detecting whether the first control system has no abnormalities can refer to the method described in the above embodiments and will not be repeated here.

When the first processor determines that there is no abnormality in the first control system, it can send a self-test command to the second processor so that the second processor detects whether there is no abnormality in the second control system. That is, after the first control system self-tests and no abnormality is found, the second control system can be instructed to perform a self-test, so that the display apparatus completes the self-test operations of the two control systems.

When the second processor detects that there is no abnormality in the second control system, in some embodiments, the second processor can feedback a self-test result indicating that there is no abnormality in the second control system to the first processor, so that the first processor knows that there is no abnormality in the second control system. Then, the first processor can control the screen to display images, and when it is determined that there is an abnormality in the first control system, it switches to the second control system and controls the screen to display images through the second processor.

When the second processor detects an abnormality in the second control system, in some embodiments, the second processor can feedback a self-test result indicating that an abnormality exists in the second control system to the first processor, so that the first processor is aware of the abnormality in the second control system. Then, in some embodiments, the first processor can output a prompt message through the screen, for example, to prompt the user that an abnormality exists in the second control system. Then, the first processor can continue to control the screen to display images through the first control device. Furthermore, in some embodiments, the first processor can further send a self-test command to the second processor again after a preset self-test duration, so that the second processor detects whether the abnormality of the second control system is restored.

When the first processor determines that there is an abnormality in the first control system, it can send a “control system switching command” to the second processor, so that the second processor can send a channel switching command to the switch device and control the screen to display images. The second processor can send a channel switching command to the switch device, so that the switch device can respond to the channel switching command, turn off the first channel, and turn on the second channel, thereby enabling the second processor to control the screen to display images.

Through the above method, during the power-on self-test process, when the display apparatus determines that there is an abnormality in the first control system, it switches to the second control system to control the screen to display images, so that the display apparatus can display images after the power-on is completed, thereby improving the user experience.

Furthermore, in some embodiments, the second processor can control the screen to display a prompt message to remind the user that there is an abnormality in the first control system after receiving the above-mentioned control system switching command, so as to let the user know that there is an abnormality in the first control system, thereby further improving the user experience.

In some embodiments, the second processor can further detect whether the first processor has an abnormality. When the second processor determines that the first processor has an abnormality, it can be determined that the communication abnormality exists in the first channel. Then, the second processor can send a channel switching command to the switch device, so that the switch device can turn off the first channel and turn on the second channel.

When the second processor determines that the first processor is normal, in some embodiments, the second processor can only maintain a communication connection with the first processor so that the first processor can send a control system switching command to the second processor when the first control system is abnormal.

In some embodiments, the second processor can determine whether the first processor is abnormal by receiving a connection request response from the first processor within a preset time period. For example, the second processor can send a connection request to the first processor. Then, when the second processor does not receive a connection request response from the first processor within a preset time period, it indicates that the first processor cannot be able to communicate normally, and the second processor can determine that the first processor is abnormal. The preset duration can be pre-stored in the second processor. When the second processor receives a connection request response from the first processor within a preset time period, indicating that the first processor can communicate normally, the second processor can determine that there is no abnormality in the first processor.

In some embodiments, the second processor can periodically send a connection request to the first processor, and after each connection request is sent, determine whether the first processor has an abnormality based on whether a connection request response is received from the first processor within a preset time period.

The above method avoids the problem that when an abnormality occurs in the first processor, the control system switching command cannot be sent to the second processor, resulting in the second processor being unable to control the screen to display images in a timely manner (that is, avoiding the occurrence of a monitoring dead loop). The second processor can actively monitor whether there is an abnormality in the first processor, and when it is determined that the first processor is abnormal, the control system is switched in a timely manner, thereby improving the efficiency of switching the control system of the display apparatus and further improving the user experience.

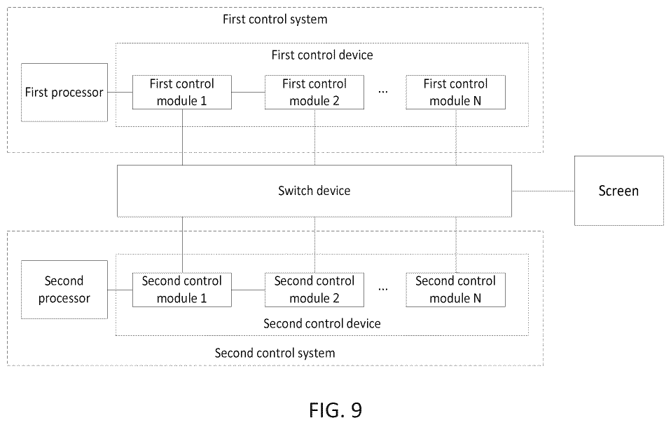

In some embodiments, the first control device and the second control device can each include a plurality of control modules with processing capabilities, and determine whether each control system is abnormal based on the control modules. In some embodiments, FIG. 9 is another schematic structural diagram of a display apparatus according to the present application. The screen of the display apparatus can include N display areas (not shown in FIG. 9). N is an integer greater than or equal to 1.

As shown in FIG. 9, the first control device can include: N first control modules. The N first control modules correspond one-to-one to the N display areas. The N first control modules are connected in series, and the first processor is connected to a first end of a first control module at a starting end of the serial connection (eg, the first control module 1 shown in FIG. 9). Each of the above-mentioned first control modules can also be connected to a display component (not shown in FIG. 9) of a screen in a corresponding display area through a switch device.

The above-mentioned second control device can include: N second control modules. The N second control modules also correspond one-to-one to the N display areas. The N second control modules are connected in series, and the second processor is connected to a first end of the second control module at the start end of the serial connection (eg, the second control module 1 shown in FIG. 9). Each of the second control modules mentioned above can also be connected to a display component (not shown in FIG. 9) of a screen in a corresponding display area through a switch device.

In this implementation, for any first control module, the first processor can control the display component connected to the first control module to display an image through the first control module.

In some embodiments, taking displaying a target image as an example, the first processor can first acquire target image data, and then send the target image data to the first control module 1 connected to the first processor. The first control module 1 can also send the target image data to the first control module 2, and so on, through the aforementioned serial connection, until the first control module N obtains the target image data from the first control module N+1. Then, each first control module can control the display component connected to the first control module to display the image according to the target image data.

As mentioned above, the first control module can be a control module with processing capabilities. In some embodiments, for any first control module, the first control module can obtain a first abnormality detection result “including a detection result for characterizing whether an abnormality occurs in the image display of the corresponding display area of the first control module” and a second abnormality detection result “including a detection result for characterizing whether an abnormality occurs in the first control module that is subsequent to and adjacent to the first control module in the above-mentioned serial connection”.

In some embodiments, the above-mentioned “whether the image display has an abnormality” can include at least one of the following: whether the display brightness of the display area is abnormal, or whether the display chromaticity of the display area is abnormal.

Whether the display brightness of the display area is abnormal can refer to: whether the display brightness of the display area is consistent with the display brightness of other display areas, and/or whether the display brightness of the display area is within a preset brightness range. For example, taking “whether the image display has an abnormality” as an example, including: whether the display brightness of the display area has an abnormality. That is, when the display brightness of the display area is inconsistent with the display brightness of other display areas, and/or the display brightness of the display area is not within the preset brightness range, then the first abnormality detection result can include: a detection result configured to characterize that there is an abnormality in the image display of the display area corresponding to the first control module. When the display brightness of the display area is consistent with the display brightness of other display areas, and the display brightness of the display area is within a preset brightness range, the first abnormality detection result can include: a detection result configured to characterize that there is no abnormality in the image display of the display area corresponding to the first control module.

Whether the display chromaticity of the display area has an abnormality can refer to: whether the display chromaticity of the display area is consistent with the display chromaticity of other display areas, and/or whether the display chromaticity of the display area is within a preset chromaticity range. For example, taking “whether the image display has an abnormality” as an example, including: whether the display chromaticity of the display area has an abnormality. When the display chromaticity of the display area is inconsistent with the display chromaticity of other display areas, and/or the display chromaticity of the display area is not within the preset chromaticity range, then the first abnormality detection result can include: a detection result configured to characterize that the image display of the display area corresponding to the first control module has an abnormality. When the display chromaticity of the display area is consistent with the display chromaticity of other display areas, and the display chromaticity of the display area is within a preset chromaticity range, the first abnormality detection result can include: a detection result configured to characterize that there is no abnormality in the image display of the display area corresponding to the first control module.

In some embodiments, the above-mentioned “whether the image display has an abnormality” can also include: whether the image display in the display area is synchronized with other display areas. When the display area displays images synchronously with other display areas, the first abnormality detection result can include: a detection result indicating that there is no abnormality in the image display of the display area corresponding to the first control module. When the image display in the display area is not synchronized with other display areas, the first abnormality detection result can include: a detection result indicating that the image display in the display area corresponding to the first control module is abnormal.

It should be understood that the present application does not limit how the first control module obtains the first abnormality detection result.

In some embodiments, taking the first control module 1 in FIG. 9 as an example, in the above serial connection, the first control module subsequent to and adjacent to the first control module 1 can be: the first control module 2. That is, the first control module 1 can obtain a second abnormality detection result “including a detection result for indicating whether the first control module 2 has an abnormality”. Taking the first control module N in FIG. 9 as an example, in the above serial connection, there is no first control module after the first control module N. In this implementation, the first control module N can obtain a second abnormality detection result “including a detection result for characterizing whether the first control module N has an abnormality”.

It should be understood that the present application does not limit how the first control module obtains the second abnormality detection result. In some embodiments, each first control module can perform a self-test and send a self-test result, which indicates whether the first control module is abnormal, to an upper-level first control module in the serial connection. In some embodiments, the first control module 3 can perform a self-test and send a self-test result indicating whether the first control module 3 is abnormal to the first control module 2, so that the first control module 2 can obtain the second test result. In some embodiments, still taking the first control module 2 as an example, after sending the above-mentioned target image data to the first control module 3, the first control module 2 can determine whether the first control module 3 is abnormal based on whether a response “for indicating that the target image data has been received” is received from the first control module 3 within a preset response time. When the first control module 2 receives a response “for indicating that the target image data has been received” from the first control module 3 within the preset response time, it can be determined that there is no abnormality in the first control module 3. When the first control module 3 does not receive a response “for indicating that the target image data has been received” from the first control module 3 within the preset response time, it can be determined that the first control module 3 has an abnormality.

Then, for any one first control module, when the first control module determines that there is an abnormality in the first control system based on the above-mentioned first abnormality detection result and the second abnormality detection result, the first control module can control the above-mentioned switch device, turn off the above-mentioned first channel, and send a control system switching command to the second processor. Then, the second processor can respond to the control system switching command, control the switch device to conduct the second channel, and control the display components connected to each second control module to display images through each second control module.

In some embodiments, the first control module can determine that there is an abnormality in the first control system when the above-mentioned first abnormality detection result indicates that there is an abnormality in the image display of the display area corresponding to the first control module, and/or the second abnormality detection result indicates that there is an abnormality in the first control module that is subsequent to and adjacent to the first control module in the above-mentioned serial connection. When the first abnormality detection result indicates that there is no abnormality in the image display of the display area corresponding to the first control module, and the second abnormality detection result indicates that there is no abnormality in the first control module after and adjacent to the first control module in the serial connection, then the first control module can determine that there is no abnormality in the first control system.

In some embodiments, the first control module can send a first channel shutdown command to the switch device when determining that the first control system has an abnormality. The switch device can respond to the first channel shutdown command to turn off the above-mentioned first channel. In some embodiments, the second processor can respond to the control system switching command and send a second channel conduction command to the switch device, so that the switch device can respond to the second channel conduction command and turn on the second channel.

The above switch device is described in detail below.

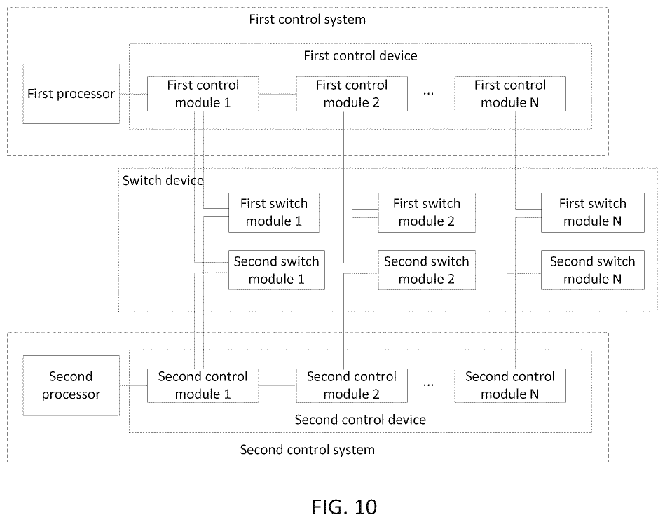

FIG. 10 is another schematic structural diagram of a display apparatus according to the present application. As shown in FIG. 10, in some embodiments, the switch device can include: N first switch modules, and N second switch modules.

The N first control modules correspond one-to-one to the N first switch modules, and the N first control modules correspond one-to-one to the N second switch modules. For any one first control module, the first control module can be connected to the display component of the screen in the corresponding display area through the first switch module corresponding to the first control module, forming a transmitting sub-channel of the first channel (not shown in FIG. 10). The first control module can be connected to the display component of the screen in the corresponding display area through the second switch module corresponding to the first control module, forming a receiving sub-channel of the first channel (not shown in FIG. 10).

In some embodiments, taking the first control module 1 in FIG. 10 as an example, the first control module 1 can be connected to the display component of the screen in the corresponding display area through the first switch module 1 to form a transmitting sub-channel of the first channel corresponding to the first control module 1.

The N second control modules correspond one-to-one to the N first switch modules, and the N second control modules correspond one-to-one to the N second switch modules. For any one second control module, the second control module can be connected to the display component of the screen in the corresponding display area through the first switch module corresponding to the second control module, forming a transmitting sub-channel of the second channel (not shown in FIG. 10). The second control module can be connected to the display component of the screen in the corresponding display area through the second switch module corresponding to the second control module, forming a receiving sub-channel of the second channel (not shown in FIG. 10).

In some embodiments, taking the second control module 1 in FIG. 10 as an example, the second control module 1 can be connected to the display component of the screen in the corresponding display area through the first switch module 1 to form a transmitting sub-channel of the second channel corresponding to the second control module 1.

In some embodiments, for any one first control module, the first control module can control the display component connected to the first control module to display images through the transmitting sub-channel of the above-mentioned first channel, and send an abnormality detection command to the display component so that the display component can feedback the first abnormality detection result. For example, the first control module can send data required for displaying the image to a display component connected to the first control module through the transmitting sub-channel of the first channel, so that the display component can drive the screen to display images. In some embodiments, the display component can obtain the first abnormality detection result by referring to any existing method for determining whether an abnormality occurs in image display by a screen, which will not be elaborated in the present application.

Correspondingly, the first control module can receive the first abnormality detection result from the display component through the receiving sub-channel of the first channel.

In some embodiments, for any one second control module, the second control module can control the display component connected to the second control module to display an image through the transmitting sub-channel of the second channel when the first control system is abnormal, and send an abnormality detection command to the display component so that the display component can feedback a third abnormality detection result “configured to characterize whether the image display of the corresponding display area of the second control module is abnormal”. For example, the second control module can send data required for displaying the image to a display component connected to the second control module through the transmitting sub-channel of the second channel, so that the display component can drive the screen to display images. In some embodiments, the third abnormality detection result of “whether the image display in the display area has an abnormality” can refer to the method described in the above embodiments and will not be repeated here.

Correspondingly, the second control module can receive the third abnormality detection result from the display component through the receiving sub-channel of the second channel. In some embodiments, the second control module can determine whether there is an abnormality in the second control system based on the third abnormality detection result.

In some embodiments, the second processor can further send a synchronous clock signal to each second control module, so as to control the display component connected to each second control module to display images simultaneously through each second control module. The second processor can send the synchronous clock signal to each second control module, so that each second control module can control the display component connected to each second control module to display images simultaneously according to the synchronous clock signal. Through the above method, the global synchronization of image display on the screen is guaranteed, further improving the user experience.

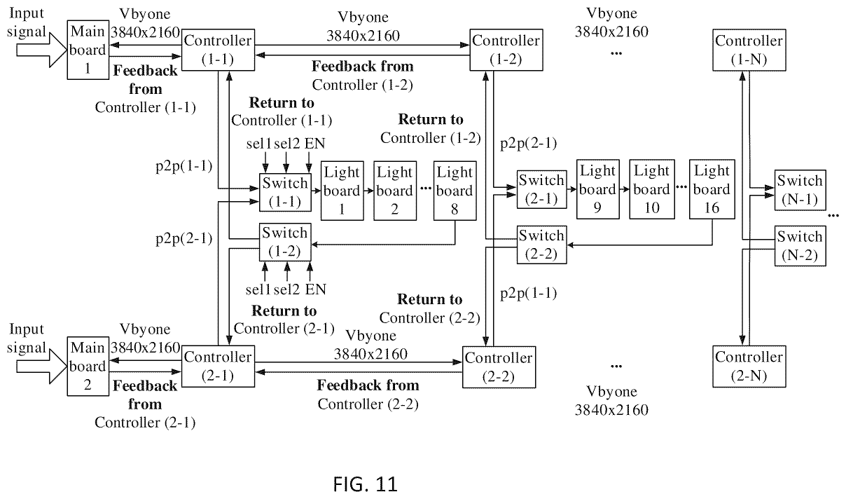

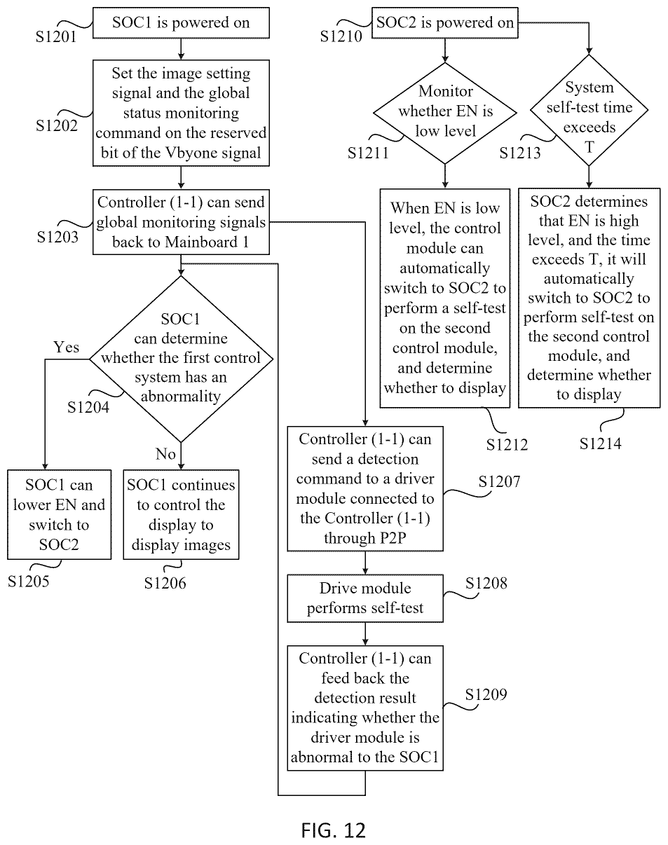

Taking the above-mentioned first processor as the mainboard 1, the second processor as the mainboard 2, the first control module 1 as the controller (1-1), the first control module 2 as the controller (1-2) . . . the first control module N as the controller (1-N); the second control module 1 as the controller (2-1), the second control module 2 as the controller (2-2) . . . the second control module N as the controller (2-N); the first switch module 1 as the switch (1-1), the first switch module 2 as the switch (2-1) . . . the first switch module N as the switch (N-1); the second switch module 1 as the switch (1-2), the second switch module 2 as the switch (2-2) . . . the second switch module N as the switch (N-2) as an example, FIG. 11 is another structural schematic diagram of a display apparatus according to the present application. Based on the display apparatus shown in FIG. 11, FIG. 12 is a flow chart of an image display method according to the present application.

As shown in FIG. 11, the light board can refer to the light board of the screen (a screen can include multiple light boards, and FIG. 11 is an exemplary explanation based on the example of the above-mentioned N display areas, where each display area includes 8 light boards. The present application does not limit the number of light boards included in a display area). In some embodiments, each light board can correspond to at least one display component (not shown in FIG. 11). In some embodiments, for any one display component, the display component can include: at least one driver module.

As shown in FIG. 11, for a display area corresponding to any one first control module, the driver modules in the display area can be connected in series. One end of the serial connection (eg, light board 1) can be connected to a first switch module (eg, switch (1-1)), and the other end of the serial connection (eg, light board 8) can be connected to a second switch module (eg, switch (1-2)). Mainboard 1 (SOC1) can receive image signal input given by the external device, and then, Mainboard 1 can output the image signal to Controller (1-1), Controller (1-1) outputs it to Controller (1-2), and so on, until it is output to Controller (1-N).

In some embodiments, as shown in FIG. 11, the corresponding relationship between Controller (1-1) and Controller (2-1) is illustrated. Controller (1-1) can be connected to the corresponding light board 1 in the display area through switch (1-1) to form the transmitting sub-channel of the first channel. Among them, light boards 1 to 8 are connected in series, and the detection data of light board 1 can be transmitted to light board 2. The detection data of light boards 1 and 2 can be transmitted to light board 3, and accumulated in sequence. The detection data of light boards 1 to 8 are collected at light board 8 for feedback to controller 1 or 2. Light board 8 is connected to Controller (1-1) through switch (1-2) to form the receiving sub-channel of the first channel. Controller (2-1) is connected to light board 1 through switch (1-1) to form the transmitting sub-channel of the second channel, and light board 8 is connected to Controller (2-1) through switch (1-2) to form the receiving sub-channel of the second channel. Among them, the transmitting sub-channel is used to send the display data and related control commands sent by the controller to the light board for display and detection. The receiving sub-channel is used to transmit the detection data of the light board back to the controller, thereby providing it to the corresponding SOC (mainboard 1 or mainboard 2).

It should be noted that the switch (1-1) can include at least two sub-channels, one sub-channel is used to form the transmitting sub-channel of the first channel, and another sub-channel is used to form the transmitting sub-channel of the second channel. Similarly, switch (1-2) can include at least two sub-channels; one sub-channel is used to form the receiving sub-channel of the first channel and another sub-channel is used to form the receiving sub-channel of the second channel. Control the selective conduction of the first and second channels through the signal line EN.

In some embodiments, when the signal line EN is at high level, the first channel is turned on and the second channel is turned off; when the signal line EN is at a low level, the second channel is turned on and the first channel is turned off.

In some embodiments, the presence of abnormalities in the first control module can be detected by the second control module. The abnormalities in the first control module are detected, such as whether the display of different display areas is synchronized, whether the signal quality is consistent, and whether the instruction status transmitted in the first control system is normal. Taking controller (2-1) to detect whether controller (1-1) is abnormal as an example, SOC2 can send a detection command to controller (2-1). Controller (2-1) can obtain the feedback result through the sub-channel formed by light board 8 and switch (1-2), and provide the result to SOC2 to determine whether controller (1-1) is abnormal.

As shown in FIG. 12, another image display method according to some embodiments of the present application can include the following operations.

S1201, SOC1 is powered on.

S1202, when outputting the image signal, the image setting signal and the global status monitoring command (for example, at least one of the aforementioned self-test command, channel switching command, and control system switching command) can be set on the reserved bit of the Vbyone signal.

Among them, SOC1 can also generate the highest priority signal to interrupt the hardware power-up and power-down interfaces.

In addition to setting the command signal on the reserved bit of Vbyone, the mainboard 1 can also add other command channels, such as 12C bus related commands, serial peripheral interface (SPI) commands, and other command channels that can achieve synchronous transmission of data and commands.

S1203, Controller (1-1) can send global monitoring signals back to Mainboard 1.

As shown in FIGS. 11 and 12, after the global status monitoring command is given to the Controller (1-1), the Controller (1-1) can send the image signal and the global status monitoring command together to the driver module on the light board 1 to light board 8 connected to the Controller (1-1) through the P2P channel and the switch (1-1). The controller (1-1) can transmit a global monitoring signal (which can include a detection result of whether the image display of the corresponding display area of all first control modules is abnormal) back to the mainboard 1, which is set as the monitoring signal C11.

S1204, SOC1 can determine whether the first control system has an abnormality (for example, whether the screen displays in different display areas are synchronized, whether the signal quality is consistent, whether the instruction status transmitted in the first control system is normal, etc.) based on the above global monitoring signal.

S1205, based on that the first control system has an abnormality, SOC1 can lower the potential of EN (ie, turned off the first channel) and switch to SOC2 (ie, globally switch to the second control system for global control). It should be noted that, when the signal line EN is at high level, the first channel is turned on and the second channel is turned off; when the signal line EN is at a low level, the second channel is turned on and the first channel is turned off.

S1206, based on that there is no abnormality in the first control system, the SOC1 continues to control the screen to display images.

The monitoring signal (such as the first detection result mentioned above) of the driver module on the light board 1 to light board 8 connected to the controller (1-1) can be transmitted back to the controller (1-1) through the switch (1-2). This monitoring signal can be defined as D11.

S1207, Controller (1-1) can send a detection command to a driver module connected to the Controller (1-1) through P2P.

S1208, each drive module can perform self-test.

After completing the self-test, each driver module can feed back the self-test result to the Controller (1-1).

S1209, Controller (1-1) can feed back the detection result indicating whether the driver module is abnormal to the SOC1.

Whether the driver module is abnormal can refer to whether the screen display corresponding to the display area is synchronized, whether the signal quality is consistent, or whether the instruction status of the driver module is normal, etc.

The time and type of return of C11 and D11 can be different. C11 can monitor whether the image display, synchronization and communication of the entire display area are normal. D11 can monitor whether the image display of the light board in the display area corresponding to the Controller (1-1) is normal, whether a certain block of a certain light board is abnormal, etc.

When there is a communication abnormality between the mainboard 1 and the Controller (1-1), the mainboard 1 cannot be able to receive the corresponding C11. Then, when the mainboard 1 does not receive the above C11 within a preset time, it can be determined that there is a communication abnormality between the mainboard 1 and the Controller (1-1). After the mainboard 1 sends the global status monitoring command, the controller (1-1) can perform a self-test and send C11 after confirming that the self-test has passed. C11 can be latched on the mainboard 1. When there is an abnormality between the mainboard 1 and the controller (1-1), the mainboard 1 can output a global switching command EN (such as the above-mentioned control system switching command) to realize the control of the switch (1-1) and the switch (1-2), thereby realizing the global switching of the system (the specific implementation refers to the above-mentioned embodiments and will not be repeated here).

When an abnormality occurs between Controller (1-1) and Controller (1-2), its implementation method can refer to the aforementioned embodiments and FIG. 11, and will not be described in detail here. This process is repeated in this way until the global monitoring of Controller n is completed and the entire system completes the backup self-test (meaning that the screen is controlled by two control systems to display images, with one control system serving as a backup).

S1210, SOC2 is powered on.

S1211, SOC2 can monitor whether EN is at a low level (i.e. whether the level of switch (1-2) is low).

S1212, when EN is at low level, the control module can automatically switch to SOC2 to perform a self-test on the second control module, and determine whether to continue controlling the screen to display based on the self-test result.

S1213, determine whether the system self-test time exceeds T.

S1214, when EN is at a high level, the first control system controls the display area and performs a self-test on the first control system. If the self-test time (referring to the self-test time of the first control system) exceeds T, even if EN is at a high level at this time, the second control system does not receive the self-test result from the first control system within T time, indicating that there is a problem with the first control system. At this time, SOC2 will be forcibly switched to control. In some embodiments, after switching to SOC2 for control, the second control module can perform a self-test and determine whether to continue controlling the screen based on the self-test results.

As shown in FIG. 11, sel1 and sel2 pointing to each switch can be configured to represent commands other than EN. For example, sel1 and sel2 can be configured to supplement the local transmission when the global command transmission of EN is not timely or the transmission bandwidth is insufficient. In some embodiments, the conduction or disconnected of sub-channels can be controlled by the cooperation of EN with sel1 and sel2.

In some embodiments, when there is an abnormality in the mainboard 1 system (first control system) by the self-test, both EN monitoring and time dimension monitoring will directly switch the system to the mainboard 2 system (second control system), rather than modular switching. This switching can effectively avoid continuous damage and secondary damage to the system. For example, when the controller stops working after being damaged, a short circuit or damage can occur, resulting in excessive leakage current. This cannot be detected explicitly in the system, and can cause damage to other modules, such as the power module. Therefore, the above method can improve the safety of the display apparatus and increase the service life of the device. Through the above-mentioned global switching, global synchronous display of the display is also guaranteed. After the global switch, the mainboard 1 system can enter a sleep or non-working state to avoid continuous damage. In addition, by adopting the method of real-time startup of the previous system backup based on the serial system, the synchronous display switching of the global forward serial system is realized, the high reliability of the system is achieved, and the global zero-delay synchronous switching is guaranteed. And through the real-time feedback synchronization switching mechanism of the above-mentioned serial return channel, it is ensured that the operation information of the user operating the display apparatus can be synchronously returned by the system, thereby ensuring that the screen setting at any time is the screen setting required by the user, further improving the user experience.

The present application further provides a non-transitory computer readable storage medium, which can include: a USB flash drive, a mobile hard disk, a read-only memory (ROM), a random access memory (RAM), a disk or an optical disk, and other media that can store program codes. Specifically, the non-transitory computer readable storage medium can store program instructions, and the program instructions can be used for the method in the above embodiments.

For the convenience of explanation, the above description has been made in conjunction with specific embodiments. However, the illustrative discussions above are not intended to be exhaustive or to limit the implementations to the precise forms disclosed above. Many modifications and variations are possible in light of the above teaching. The selection and description of the above embodiments are intended to better explain the principles and practical applications, so that those skilled in the art can better use the embodiments and various modified embodiments suitable for specific use considerations.

What is claimed is:

1. A display apparatus, comprising:
a screen configured to display an image;
a user interface configured to receive a command from a user;
a communication device configured to communicate with an external device according to a predetermined protocol;
a memory configured to store computer instructions and data associated with the display apparatus;
at least one processor, connected to the screen, the user interface, the communication device and the memory, and comprising a first processor and a second processor;
a first control system, a second control system, and a switch device; wherein:
the screen comprises N display areas; wherein N is an integer greater than 1;
the first control system comprises: the first processor and N first control modules; wherein the N first control modules are connected in series to form a first serial link, the first processor is connected to one end of a 1st first control module in the first serial link; each of the N first control module is connected to a display component of the screen in a corresponding display area through the switch device; the N first control modules correspond one-to-one to the N display areas;
the second control system comprises: the second processor and N second control modules; wherein the N second control modules are connected in series to form a second serial link, and the second processor is connected to one end of a 1st second control module in the second serial link; each of the N second control module is connected to a display component of the screen in a corresponding display area through the switch device; the N second control modules correspond one-to-one to the N display areas; a display area corresponding to a i-th first control module in the first serial link is same as a display area corresponding to a (N−i+1)th second control module in the second serial link; i is an integer greater than or equal to 1 and less than N;
the i-th first control module in the first serial link is configured to execute the computer instructions to enable the display apparatus to:
detect whether a (i+1)th first control module in the first serial link has an abnormality;
based on that the (i+1)th first control module has an abnormality, send indication information indicating that the (i+1)th first control module has an abnormality to the first processor and the second processor through the switch device;
the first processor is configured to execute the computer instructions to enable the display apparatus to: in response to the indication information, control display areas corresponding to the 1st first control module to the i-th first control module in the first serial link to display an image;
the second processor is configured to execute the computer instructions to enable the display apparatus to: in response to the indication information, control display areas corresponding to the 1st second control module to a (N−i)th second control module in the second serial link to display an image.

2. The display apparatus according to claim 1, wherein the second processor is further configured to execute the computer instructions to enable the display apparatus to:
after controlling the display areas corresponding to the 1st second control module to a (N−i)th second control module in the second serial link to display the image, detect whether the i-th first control module in the first serial link has an abnormality by a (N−i+1)th second control module in the second serial link;
based on that the i-th first control module in the first serial link has an abnormality, switch a i-th display area corresponding to the i-th first control module to be controlled by the (N−i+1)th second control module in the second serial link;
detect whether a (i−1)-th first control module in the first serial link has an abnormality by a (N−i+2)th second control module in the second serial link until a corresponding first control module in the first serial link being normal; or detect whether a (i−1)-th first control module in the first serial link has an abnormality by a (N−i+2)th second control module in the second serial link until an abnormality in the 1st first control module has been detected and all display areas are controlled by the second control system.

3. The display apparatus according to claim 1, wherein the second processor is further configured to execute the computer instructions to enable the display apparatus to:
after controlling the display areas corresponding to the 1st second control module to the (N−i)th second control module in the second serial link to display the image, detect, through the 1st second control module in the second serial link, whether a N-th first control module in the first serial link has received data required for displaying the image;
based on that the N-th first control module in the first serial link has not received the data required for displaying the image, control the N display areas to display the image through the N second control modules.

4. The display apparatus according to claim 3, wherein the display component corresponding to any of the display areas comprises at least one driver module, and any of the first control modules is connected to the at least one driver module in a corresponding display area;
wherein the second processor is further configured to execute the computer instructions to enable the display apparatus to:
before controlling the N display areas to display the image through the N second control modules, delete the data required for displaying the image cached by the at least one driver module in the display areas corresponding to the 1st first control module to the i-th first control module in the first serial link.

5. The display apparatus according to claim 1, wherein the first processor is further configured to execute the computer instructions to enable the display apparatus to:
after the first processor is powered on, send first image data segmentation information to each of the N first control modules;
wherein the first image data segmentation information is configured to enable the first control module to segment image data received from the first processor according to the first image data segmentation information, obtain image sub-data corresponding to the first control module, and control a display area corresponding to the first control module to display the image according to the image sub-data.

6. The display apparatus according to claim 5, wherein the first processor is further configured to execute the computer instructions to enable the display apparatus to:
after the first processor is powered on, send a self-test command to a N-th second control module in the second serial link through the 1st first control module in the first serial link;
the second processor is further configured to execute the computer instructions to enable the display apparatus to:
after the second processor is powered on, receive the self-test command through the N-th second control module in the second serial link;
perform a self-test in response to the self-test command; and
send second image data segmentation information to each of the N second control modules;
wherein the second image data segmentation information is configured to enable the second control module to: segment image data received from the second processor according to the second image data segmentation information, obtain image sub-data corresponding to the second control module, and control a display area corresponding to the second control module to display the image according to the image sub-data.

7. The display apparatus according to claim 6, wherein the second processor is further configured to execute the computer instructions to enable the display apparatus to:
based on that the self-test command is not received within a preset time period, control the N display areas to display the image through the N second control modules.

8. The display apparatus according to claim 1, wherein the first processor and the second processor are connected through a High Definition Multimedia Interface (HDMI) cable;
wherein the first processor is further configured to execute the computer instructions to enable the display apparatus to:
obtain image data; and
send the image data to the second processor through the HDMI cable, to enable the second processor to control the display areas corresponding to the 1st second control module to the (N−i)th second control module in the second serial link to display the image according to the image data;
or,
wherein the second processor is further configured to execute the computer instructions to enable the display apparatus to:
obtain image data; and
send the image data to the first processor through the HDMI cable, to enable the first processor to control the display areas corresponding to the 1st first control module to the i-th first control module in the first serial link to display the image according to the image data.

9. The display apparatus according to claim 1, wherein based on that the (i+1)th first control module has an abnormality, the i-th first control module is further configured to execute the computer instructions to enable the display apparatus to:
control the switch device to shut down a first channel between the (i+1)th first control module to a N-th first control module in the first serial link and the display component corresponding to the (i+1)th first control module to the N-th first control module in the first serial link;
send the indication information to the first processor step by step through the (i−1)th first control module to the 1st first control module in the first serial link;
control the switch device to conduct a second channel between the 1st second control module to the (N−i)th second control module in the second serial link and the display component corresponding to the 1st second control module to the (N−i)th second control module in the second serial link; and
send the indication information to the second processor step by step through the (N−i)th second control module to the 1st second control module in the second serial link.

10. The display apparatus according to claim 9, wherein the switch device comprises: N first switch modules and N second switch modules;
the N first control modules correspond one-to-one to the N first switch modules, and the N first control modules correspond one-to-one to the N second switch modules;
for any one of the N first control modules, the first control module is connected to the display component of the display in the display area corresponding to the first control module through the first switch module corresponding to the first control module, to form a transmitting sub-channel of the first channel; and the first control module is connected to the display component of the display in the display area corresponding to the first control module through the second switch module corresponding to the first control module, to form a receiving sub-channel of the first channel;
the first control module is further configured to execute the computer instructions to enable the display apparatus to:
control the display component connected to the first control module to display the image through the transmitting sub-channel of the first channel based on that the first channel is turned on;
send a first abnormality detection command to the display component; and
receive a first abnormality detection result from the display component through the receiving sub-channel of the first channel; wherein the first abnormality detection result is configured to indicate whether the display component has an abnormality;
wherein the N second control modules correspond one-to-one to the N first switch modules, and the N second control modules correspond one-to-one to the N second switch modules;
for any one of the N second control modules, the second control module is connected to the display component of the screen in the display area corresponding to the second control module through the first switch module corresponding to the second control module, to form a transmitting sub-channel of the second channel; and the second control module is connected to the display component of the screen in the display area corresponding to the second control module through the second switch module corresponding to the second control module, to form a receiving sub-channel of the second channel;
the second control module is further configured to execute the computer instructions to enable the display apparatus to:
control the display component connected to the second control module to display the image through the transmitting sub-channel of the second channel based on that the second channel is turned on;
send a second abnormality detection command to the display component; and
receive a second abnormality detection result from the display component through the receiving sub-channel of the second channel; wherein the second abnormality detection result is configured to indicate whether the display component has an abnormality.

11. An image display method, applied to a display apparatus, wherein the display apparatus comprises:
a screen configured to display an image;
a user interface configured to receive a command from a user;
a communication device configured to communicate with an external device according to a predetermined protocol;
a memory configured to store computer instructions and data associated with the display apparatus;
at least one processor connected to the screen, the user interface, the communication device and the memory, and comprising a first processor and a second processor;
a first control system, a second control system, and a switch device; wherein:
the screen comprises N display areas; wherein N is an integer greater than 1;
the first control system comprises: the first processor and N first control modules; wherein the N first control modules are connected in series to form a first serial link, the first processor is connected to one end of a 1st first control module in the first serial link; each of the N first control module is connected to a display component of the screen in a corresponding display area through the switch device; the N first control modules correspond one-to-one to the N display areas;
the second control system comprises: the second processor and N second control modules;
wherein the N second control modules are connected in series to form a second serial link, and the second processor is connected to one end of a 1st second control module in the second serial link; each of the N second control module is connected to a display component of the screen in a corresponding display area through the switch device; the N second control modules correspond one-to-one to the N display areas; a display area corresponding to a i-th first control module in the first serial link is same as a display area corresponding to a (N−i+1)th second control module in the second serial link; i is an integer greater than or equal to 1 and less than N;
wherein the method comprises:
detecting, through the i-th first control module in the first serial link, whether a (i+1)th first control module in the first serial link has an abnormality;
based on that the (i+1)th first control module has an abnormality, sending indication information indicating that the (i+1)th first control module has an abnormality to the first processor and the second processor through the switch device;
controlling, by the first processor, display areas corresponding to the 1st first control module to the i-th first control module in the first serial link to display an image in response to the indication information;
controlling, by the second processor, display areas corresponding to the 1st second control module to a (N−i)th second control module in the second serial link to display an image in response to the indication information.

12. The image display method according to claim 11, wherein after controlling the display areas corresponding to the 1st second control module to a (N−i)th second control module in the second serial link to display the image, the method further comprises:
detecting whether the i-th first control module in the first serial link has an abnormality by a (N−i+1)th second control module in the second serial link;
based on that the i-th first control module in the first serial link has an abnormality, switching a i-th display area corresponding to the i-th first control module to be controlled by the (N−i+1)th second control module in the second serial link;
detecting whether a (i−1)-th first control module in the first serial link has an abnormality by a (N−i+2)th second control module in the second serial link until a corresponding first control module in the first serial link being normal; or detecting whether a (i−1)-th first control module in the first serial link has an abnormality by a (N−i+2)th second control module in the second serial link until an abnormality in the 1st first control module has been detected and all display areas are controlled by the second control system.

13. The image display method according to claim 11, wherein after controlling the display areas corresponding to the 1st second control module to the (N−i)th second control module in the second serial link to display the image, the method further comprises:
detecting, by the second processor, whether a N-th first control module in the first serial link has received data required for displaying the image through the 1st second control module in the second serial link;
based on that the N-th first control module in the first serial link has not received the data required for displaying the image, controlling the N display areas to display the image through the N second control modules.

14. The image display method according to claim 13, wherein the display component corresponding to any of the display areas comprises at least one driver module, and any of the first control modules is connected to the at least one driver module in a corresponding display area;
wherein before controlling the N display areas to display the image through the N second control modules, the method further comprises:
deleting, by the second processor, the data required for displaying the image cached by the at least one driver module in the display areas corresponding to the 1st first control module to the i-th first control module in the first serial link.

15. The image display method according to claim 11, further comprising:
sending, by the first processor, first image data segmentation information to each of the N first control modules after the first processor is powered on;
wherein the first image data segmentation information is configured to enable the first control module to segment image data received from the first processor according to the first image data segmentation information, obtain image sub-data corresponding to the first control module, and control a display area corresponding to the first control module to display the image according to the image sub-data.

16. The image display method according to claim 15, further comprising:
sending, by the first processor, a self-test command to a N-th second control module in the second serial link through the 1st first control module in the first serial link after the first processor is powered on;
receiving, by the second processor, the self-test command through the N-th second control module in the second serial link after the second processor is powered on;
performing, by the second processor, a self-test in response to the self-test command; and
sending, by the second processor, second image data segmentation information to each of the N second control modules;
wherein the second image data segmentation information is configured to enable the second control module to: segment image data received from the second processor according to the second image data segmentation information, obtain image sub-data corresponding to the second control module, and control a display area corresponding to the second control module to display the image according to the image sub-data.

17. The image display method according to claim 16, further comprising:
controlling, by the second processor, the N display areas to display the image through the N second control modules based on that the self-test command is not received within a preset time period.

18. The image display method according to claim 11, wherein the first processor and the second processor are connected through a High Definition Multimedia Interface (HDMI) cable;
wherein the method further comprises:
obtaining, by the first processor, image data; and sending, by the first processor, the image data to the second processor through the HDMI cable, to enable the second processor to control the display areas corresponding to the 1st second control module to the (N−i)th second control module in the second serial link to display the image according to the image data;
or,
obtaining, by the second processor, image data; and sending, by the second processor, the image data to the first processor through the HDMI cable, to enable the first processor to control the display areas corresponding to the 1st first control module to the i-th first control module in the first serial link to display the image according to the image data.

19. The image display method according to claim 11, wherein based on that the (i+1)th first control module has an abnormality, the method further comprises:
controlling, by the i-th first control module, the switch device to shut down a first channel between the (i+1)th first control module to a N-th first control module in the first serial link and the display component corresponding to the (i+1)th first control module to the N-th first control module in the first serial link;
sending, by the i-th first control module, the indication information to the first processor step by step through the (i−1)th first control module to the 1st first control module in the first serial link;
controlling, by the i-th first control module, the switch device to conduct a second channel between the 1st second control module to the (N−i)th second control module in the second serial link and the display component corresponding to the 1st second control module to the (N−i)th second control module in the second serial link; and
sending, by the i-th first control module, the indication information to the second processor step by step through the (N−i)th second control module to the 1st second control module in the second serial link.

20. The image display method according to claim 19, wherein the switch device comprises:
N first switch modules and N second switch modules;
the N first control modules correspond one-to-one to the N first switch modules, and the N first control modules correspond one-to-one to the N second switch modules;
for any one of the N first control modules, the first control module is connected to the display component of the screen in the display area corresponding to the first control module through the first switch module corresponding to the first control module, to form a transmitting sub-channel of the first channel; and the first control module is connected to the display component of the screen in the display area corresponding to the first control module through the second switch module corresponding to the first control module, to form a receiving sub-channel of the first channel;
wherein the method further comprises:
controlling, by the first control module, the display component connected to the first control module to display the image through the transmitting sub-channel of the first channel based on that the first channel is turned on;
sending, by the first control module, a first abnormality detection command to the display component; and
receiving, by the first control module, a first abnormality detection result from the display component through the receiving sub-channel of the first channel; wherein the first abnormality detection result is configured to indicate whether the display component has an abnormality;
wherein the N second control modules correspond one-to-one to the N first switch modules, and the N second control modules correspond one-to-one to the N second switch modules;
for any one of the N second control modules, the second control module is connected to the display component of the screen in the display area corresponding to the second control module through the first switch module corresponding to the second control module, to form a transmitting sub-channel of the second channel; and the second control module is connected to the display component of the screen in the display area corresponding to the second control module through the second switch module corresponding to the second control module, to form a receiving sub-channel of the second channel;
wherein the method further comprises:
controlling, by the second control module, the display component connected to the second control module to display the image through the transmitting sub-channel of the second channel based on that the second channel is turned on;
sending, by the second control module, a second abnormality detection command to the display component; and
receiving, by the second control module, a second abnormality detection result from the display component through the receiving sub-channel of the second channel; wherein the second abnormality detection result is configured to indicate whether the display component has an abnormality.
